(19) United States
(12) Patent Application Publication
(10) Pub. No.: US 2026/0364459 A1
(43) Pub. Date: Nov. 19, 2026

(54) VIRTUAL CHARACTER CONCEALMENT METHOD, RELATED APPARATUS, DEVICE, AND STORAGE MEDIUM

(71) Applicant: Tencent Technology (Shenzhen) Company Limited, Shenzhen (CN)

(72) Inventor: Zequan ZHANG, Shenzhen (CN)

(21) Appl. No.: 19/735,342

(22) Filed: Jul. 8, 2026

Related U.S. Application Data
(63) Continuation of application No. PCT/CN2025/104326, filed on Jun. 27, 2025.

(30) Foreign Application Priority Data
Aug. 15, 2024 (CN) 202411125147.3

(51) Int. Cl. A63F 13/57; A63F 13/52

(52) U.S. Cl. CPC A63F 13/57; A63F 13/52

(57) ABSTRACT

This application discloses a virtual character concealment method performed by a computer device. The method includes: after the first virtual character enters a target virtual environment, determining at least one type of environment material in a surrounding environment; displaying an animation of adding a target camouflage pattern to the first virtual character within first time duration, and the target camouflage pattern being derived from the at least one type of environment material; and switching the first virtual character from an exposed display state to a concealed display state when the first time duration ends, the first virtual character in the concealed display state being less visible in the target virtual environment.

### CROSS-REFERENCE TO RELATED APPLICATIONS

This application is a continuation application of PCT Patent Application No. PCT/CN2025/104326, entitled “VIRTUAL CHARACTER CONCEALMENT METHOD, RELATED APPARATUS, DEVICE, AND STORAGE MEDIUM” filed on Jun. 27, 2025, which claims priority to Chinese Patent Application No. 202411125147.3, entitled “VIRTUAL CHARACTER CONCEALMENT METHOD, RELATED APPARATUS, DEVICE, AND STORAGE MEDIUM” filed with the China National Intellectual Property Administration on Aug. 15, 2024, both of which are incorporated herein by reference in their entirety.

### FIELD OF THE TECHNOLOGY

This application relates to the field of computer technologies, and more specifically, to virtual character concealment.

### BACKGROUND OF THE DISCLOSURE

With continuous development of game technologies, developers provide various game playing methods for players in games. In a war simulation game, a player may use various environments and props to perform ambush and concealment and obtain tactical advantages. These strategies include, but are not limited to, using grass, buildings, obstacles, and the like to conceal oneself, while observing and waiting for an opponent to appear.

In the related art, to better achieve a concealment effect, the player may use a special prop or skill to enhance the concealment effect of the player. For example, the player uses camouflage clothing, such as leaf-patterned attire or military camouflage outfits, to disguise a virtual character, which reduces the likelihood of the virtual character being recognized by another player.

However, camouflage clothing is monotonous and lacks variety, which makes it difficult to adapt to different game scenes and results in a poor concealment effect. In view of this, there is an urgent need for an effective method to solve such problems.

### SUMMARY

Embodiments of this application provide a virtual character concealment method, a related apparatus, a device, and a storage medium, to simulate a realistic battlefield concealment effect, which not only improves realism of concealment, but also enhances a concealment effect of a virtual character.

In view of this, according to an aspect, this application provides a method for concealing a first virtual character in a target virtual environment performed by a computer device, the method including:
after the first virtual character enters the target virtual environment, determining at least one type of environment material in a surrounding environment;
displaying an animation of adding a target camouflage pattern to the first virtual character within first time duration, and the target camouflage pattern being derived from the at least one type of environment material; and
switching the first virtual character from an exposed display state to a concealed display state when the first time duration ends, the first virtual character in the concealed display state being less visible in the target virtual environment.

According to another aspect, this application provides a computer device, including a memory and a processor. The memory has a computer program stored therein, and the processor, when executing the computer program, implements the method according to the foregoing aspect.

According to another aspect, this application provides a non-transitory computer-readable storage medium, having a computer program stored therein. The computer program, when executed by a processor, implements the method according to the foregoing aspect.

It can be seen from the foregoing technical solutions that the embodiments of this application have the following advantages:

In the embodiments of this application, the virtual character concealment method is provided. After entering the target virtual environment, the first virtual character may perform the concealment operation. In this case, the surrounding environment in which the first virtual character is currently located needs to be obtained. The smearing animation of the first virtual character is played within the first time duration, and the coating effect is displayed on an interface, to simulate a realistic battlefield concealment effect and enhance realism of concealment. After the first time duration ends, the first virtual character changes from the original exposed display state to the concealed display state. That is, in this case, the first virtual character has already blended with the surrounding environment, to adapt to different game scenes. In this way, game immersion is improved, and a virtual character can be well concealed in a current environment, to enhance a concealment effect. Furthermore, compared with a solution of developing a plurality of camouflage clothing, concealing the first virtual character based on the surrounding environment can reduce types and texture resources of camouflage clothing designed in advance, and can support more camouflage effects while reducing development costs.

### BRIEF DESCRIPTION OF THE DRAWINGS

FIG. 1 is a schematic diagram of an implementation environment of a virtual character concealment method according to an embodiment of this application.

FIG. 2 is a schematic flowchart of a virtual character concealment method according to an embodiment of this application.

FIG. 3 is a schematic distribution diagram of a target virtual environment according to an embodiment of this application.

FIG. 4 is a schematic diagram of triggering a concealment operation based on a surrounding environment according to an embodiment of this application.

FIG. 5 is another schematic diagram of triggering a concealment operation based on a surrounding environment according to an embodiment of this application.

FIG. 6 is a schematic diagram of a concealment process of a first-person virtual character according to an embodiment of this application.

FIG. 7 is a schematic diagram of a concealment process of a third-person virtual character according to an embodiment of this application.

FIG. 8 is a schematic diagram of displaying a concealment control according to an embodiment of this application.

FIG. 9 is a schematic diagram of using a first virtual prop for concealment according to an embodiment of this application.

FIG. 10 is a related schematic diagram of displaying remaining duration of state switching according to an embodiment of this application.

FIG. 11 is a schematic diagram of interrupting a concealment process according to an embodiment of this application.

FIG. 12 is a schematic diagram of continuing a concealment process according to an embodiment of this application.

FIG. 13 is a schematic diagram of adding an environment asset type to a character model according to an embodiment of this application.

FIG. 14 is a schematic diagram of implementing concealment based on a target virtual environment according to an embodiment of this application.

FIG. 15 is a schematic diagram of restoring to an exposed display state according to an embodiment of this application.

FIG. 16 is a schematic diagram of using a second virtual prop according to an embodiment of this application.

FIG. 17 is another schematic diagram of using a second virtual prop according to an embodiment of this application.

FIG. 18 is a schematic diagram of obtaining a second virtual prop according to an embodiment of this application.

FIG. 19 is a schematic diagram of supporting teammate-assisted concealment according to an embodiment of this application.

FIG. 20 is a schematic overall flowchart of a virtual character concealment method according to an embodiment of this application.

FIG. 21 is a schematic diagram of a virtual character concealment apparatus according to an embodiment of this application.

FIG. 22 is a schematic structural diagram of a terminal according to an embodiment of this application.

### DESCRIPTION OF EMBODIMENTS

Embodiments of this application provide a virtual character concealment method, a related apparatus, a device, and a storage medium, to simulate a realistic battlefield concealment effect, which not only improves realism of concealment, but also enhances a concealment effect of a virtual character.

In the description, claims, and drawings of this application, the terms “first”, “second”, “third”, “fourth”, and the like (if any) are intended to distinguish between similar objects, but do not necessarily indicate a specific order or sequence. Data used in such a way is interchangeable in a proper case. Therefore, the embodiments of this application described herein can be implemented, for example, in an order other than the sequence illustrated or described herein. In addition, the terms “include”, “correspond to”, and any other variants thereof are intended to cover a non-exclusive inclusion. For example, a process, method, system, product, or device that includes a series of operations or units not only includes those operations or units specified expressly, but also includes other operations or units that are not specified expressly or are inherent to the process, method, product, or device.

In the embodiments of this application, the term “module” or “unit” refers to a computer program or a part of a computer program with a predetermined function, which operates together with another related part to achieve a predetermined objective, and may be fully or partially implemented using software, hardware (such as a processing circuit or a memory), or a combination thereof. Similarly, one processor (or a plurality of processor or a plurality of memories) may be configured to implement one or more modules or units. In addition, each module or unit may be a part of an integrated module or unit that includes the functionality of the module or unit.

In a game application, a player needs to cover himself/herself by using various elements in an environment, for example, hiding in grass or wearing camouflage clothing, to maintain concealment. This behavior not only helps the player avoid being detected by an opponent in a task execution process, but also improves a survival rate and task completion efficiency of the player.

A war simulation game refers to a multiplayer online shooting game mode that simulates a large-scale combat scene and emphasizes teamwork and strategic planning. Its core gameplay revolves around real-time player-versus-player battles, emphasizes the importance of teamwork, and requires players to work closely with teammates to jointly complete tasks and achieve objectives. The player further needs to formulate strategies and plans, and properly allocate resources and troops to deal with attacks and defenses of the opponent. Therefore, an ambush strategy is one of the most important gameplay elements, involving setting up a fixed-point ambush along an attack route of the opponent to strike advancing opponent forces. Currently, in many war simulation games, due to a rendering discrepancy between a game character and a scene, the virtual character controlled by the player appears very conspicuous in a battlefield scene and can be easily detected by the opponent at a glance, which lacks a sense of realism. In an actual battlefield, a soldier uses assets in a surrounding environment, such as mud, grass, and wood, to decorate himself/herself and conceal his/her body to avoid being detected by the opponent.

Based on this, this application provides a virtual character concealment method, which allows a virtual character to use a local environment asset in a game to conceal itself and avoid being detected by an opponent. After a player triggers a concealment function for a virtual character, a self-coating action of the virtual character is played, and a coating effect also appears on a screen view of the player. Meanwhile, virtual object materials in a scene are comprehensively blended with a character material. In this way, an appearance material of the virtual character becomes close to a material in a surrounding environment, to achieve a concealment effect. However, when the virtual character moves, the material blending effect is gradually lost, to simulate a realistic battlefield concealment effect. This satisfies game experience of camouflaging and setting up a fixed-point ambush against opponent forces in a simulated battlefield.

Before a specific method of this application is described, an application scenario of this application is first exemplarily described. The following application scenario is merely an example for description, and this application is not actually limited thereto.

In some embodiments, the virtual character concealment method provided in the embodiments of this application is applicable to a first-person shooter (FPS) game. An FPS game is a type of game that is played from a subjective perspective of a player. In this type of game, the player feels as if he/she is personally on the scene, and what he/she sees through the screen is just like what he/she sees with his/her own eyes. Exemplarily, a description is made by using an example in which the virtual character concealment method is applied to an FPS game.

A player controls a virtual character (such as a soldier A) to enter a target virtual environment (such as shrubs in the game), and then, the player may trigger a concealment operation. Then, a surrounding environment of a position of the soldier A is obtained from the shrub environment. The surrounding environment includes a material corresponding to a shrub. In this way, the player may watch, on a terminal screen, an animation of the soldier A applying a specified pigment to the body of the soldier A, and an animation effect lasts for a period of time (such as 5 seconds). Meanwhile, a coating effect gradually appears around the periphery of the terminal screen, to simulate an effect of the soldier A applying coating to the face of the soldier A, and the coating effect on the screen may be adjusted based on a type of the surrounding environment. For example, a shrub effect is displayed in the shrub environment. After playback of the animation is completed, the soldier A is switched from an exposed display state, in which an opponent can easily detect the soldier A, to a concealed display state. In this case, material blending has been performed on a character material of the soldier A and the material (such as a shrub) of the surrounding environment, to make the soldier A close to the shrub environment visually.

Based on this, in the FPS game, strategies and realism of the game can be significantly increased. In this way, the player needs to carefully select a concealment place and timing in the game, to improve a survival probability and a battle advantage of the player.

In some other embodiments, the virtual character concealment method provided in the embodiments of this application is further applicable to a virtual reality (VR) game. The VR game is an immersive gaming experience created through a VR technology. Through devices such as a head-mounted display, it provides a player with visual, auditory, and even tactile experiences, to make the player feel as if he/she is completely immersed in a virtual world.

Exemplarily, the player manipulates a virtual character (such as a soldier B) to enter a target virtual environment (such as a loess land in the game), and then, the player may trigger a concealment operation. Then, a surrounding environment of a position of the soldier B is obtained from a loess environment. The surrounding environment includes a material corresponding to loess. In this way, the player may use a VR controller to simulate an action of smearing himself/herself, to enable another player in a same game camp to view an image of the player smearing himself/herself. Meanwhile, through a VR headset, the player can view that a coating effect gradually appears around the periphery of the field of view, which simulates an effect of being covered after coating, and the coating effect can be adjusted based on a type of the surrounding environment. For example, a loess effect is displayed in the loess environment. After the player finishes the smearing action, the soldier B is switched from an exposed display state, in which an opponent can easily detect the soldier B, to a concealed display state. In this case, material blending has been performed on a character material of the soldier B and the material (such as loess) of the surrounding environment, to make it difficult to detect the soldier B in the loess environment.

Based on this, in the VR game, the sense of immersion and tension of the player can be significantly enhanced. The player no longer just watches through a screen; and instead, he/she experiences the concealment process of the character as if he/she is personally involved. This further tests a strategic choice and timing of the player, and adds excitement and challenges to the game.

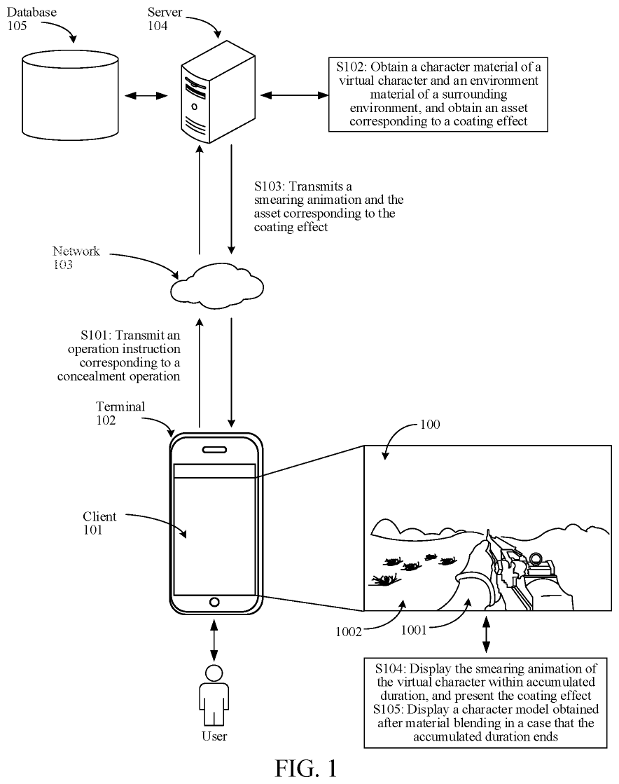

The method provided in this application is applicable to an implementation environment shown in FIG. 1. The implementation environment includes, but is not limited to, a terminal 102, a network 103, a server 104, and a database 105.

A client 101 runs on the terminal 102 (as shown in FIG. 1, an example in which the client 101 is a game client is used). The terminal 102 includes a human-computer interaction screen, a processor, and a memory. The human-computer interaction screen is configured to display a target virtual environment 100 (a virtual character 1001 shown in FIG. 1 is executing a game task in the target virtual environment 100). The human-computer interaction screen is further configured to provide a human-computer interaction interface, to receive a human-computer interaction operation configured for controlling the virtual character 1001. The processor is configured to generate an interaction instruction in response to the human-computer interaction operation, and transmit the interaction instruction to the server 104. The memory is configured to store attribute data related to the virtual character, such as prop information.

The terminal 102 of this application includes, but is not limited to, a mobile phone, a tablet computer, a notebook computer, a desktop computer, a smart voice interaction device, a virtual reality device, a smart home appliance, an in-vehicle terminal, an aircraft, and the like. A client is deployed on the terminal 102. The client 101 may run on the terminal 102 in the form of a browser, or may run on the terminal 102 in the form of a standalone application (APP), a mini program, or the like.

The network 103 uses standard communication technologies and/or protocols, and is typically the Internet, or may alternatively be any network, including but not limited to Bluetooth, a local area network (LAN), a metropolitan area network (MAN), a wide area network (WAN), or any combination of a mobile network, a dedicated network, or a virtual dedicated network. In some embodiments, custom or dedicated data communication technologies may be used to replace or supplement the foregoing data communication technologies.

The server 104 includes a processor. The processor is configured to perform a storage or read operation on the database 105. The server 104 of this application may be an independent physical server, or may be a server cluster or distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence (AI) platform.

With reference to the foregoing implementation environment, S101: The terminal 102 responds to a concealment operation of a user for a virtual character 1001 when the virtual character 1001 enters a target virtual environment 100. In this way, the terminal 102 transmits an operation instruction corresponding to the concealment operation to the server 104 over the network 103. S102: The server 104 determines, based on a current position of the virtual character 1001, an environment material corresponding to a surrounding environment 1002 in which the virtual character 1001 is located. Then, the server 104 further determines an asset required for a coating effect. S103: The server 104 transmits an animation and the asset (such as a shrub asset) corresponding to the coating effect to the terminal 102 over the network 103. S104: The terminal 102 displays the animation of the virtual character within time duration, and presents the coating effect based on the corresponding asset. S105: The terminal 102 displays a character model obtained after material blending when the time duration ends.

Exemplarily, the terminal 102 may locally implement the foregoing process. That is, after responding to the concealment operation of the user for the virtual character 1001, the terminal 102 may directly determine, based on the current position of the virtual character 1001, the environment material corresponding to the surrounding environment 1002 in which the virtual character 1001 is located. Then, the terminal 102 locally extracts the asset required for the coating effect, displays the animation of the virtual character within the time duration, and presents the coating effect based on the corresponding asset. Finally, when the time duration ends, the character model obtained after material blending is displayed.

With reference to the foregoing description, the virtual character concealment method in this application is described below. A virtual concealment method according to an embodiment of this application may be performed by a terminal alone, or performed cooperatively by a computer device (e.g., a terminal) and a server. The method provided in this application includes:
S201: In response to a concealment operation for the first virtual character when the first virtual character enters a target virtual environment, the computer device obtains a surrounding environment in which a first virtual character is located, the surrounding environment being a virtual environment in the target virtual environment, and the surrounding environment including at least one type of environment material. For example, the computer device determines at least one type of environment material in a surrounding environment after the first virtual character enters the target virtual environment.

In one or more embodiments, after a player (namely, a real player or a simulated player controlled by AI) controls the first virtual character to enter the target virtual environment, the concealment operation for the first virtual character may be triggered. Then, the surrounding environment in which the first virtual character is located is determined from the target virtual environment based on a current position of the first virtual character. The target virtual environment is a particular virtual environment, such as a loess environment or a shrub environment. The surrounding environment in which the first virtual character is located is a virtual environment in the target virtual environment, and may be understood as virtual scene elements within a specific range centered on the position of the first virtual character. The virtual environment refers to a digital, non-real environment created through a technology such as a computer technology, a graphics technology, or a simulation technology. For example, the virtual environment may be a virtual battlefield or a virtual forest, includes various elements such as terrain, buildings, vegetation, and weather, and provides a space and a scene for activities and interactions of the virtual character. The virtual character refers to a digitalized object created in the virtual environment. For example, the virtual character may be a game character or an animal manipulated by the player, and has a particular appearance, attributes, skills, and behavior characteristics. The first virtual character is one virtual character. The concealment operation is an operation configured for concealing the virtual character. For example, the concealment operation for the first virtual character is an operation configured for concealing the first virtual character.

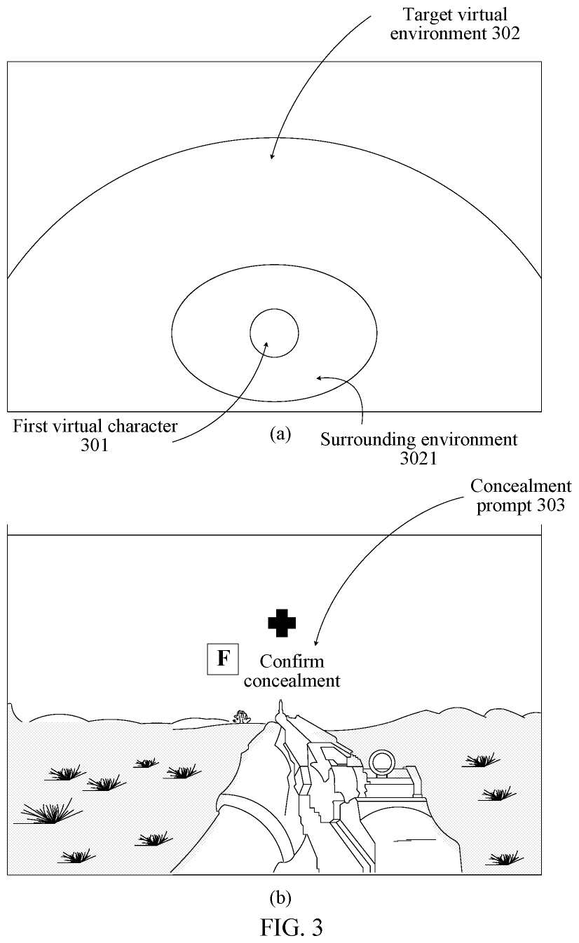

FIG. 3 is a schematic distribution diagram of a target virtual environment according to an embodiment of this application. As shown in (a) in FIG. 3, 301 indicates the first virtual character, 302 indicates the target virtual environment, and 3021 indicates the surrounding environment in which the first virtual character is located. When the first virtual character enters the target virtual environment, an interface shown in (b) in FIG. 3 is displayed. 303 indicates a concealment prompt. That is, the player may trigger the concealment operation for the first virtual character through a key (such as an “F” key) on a peripheral device (such as a keyboard) based on the concealment prompt indicated by 303.

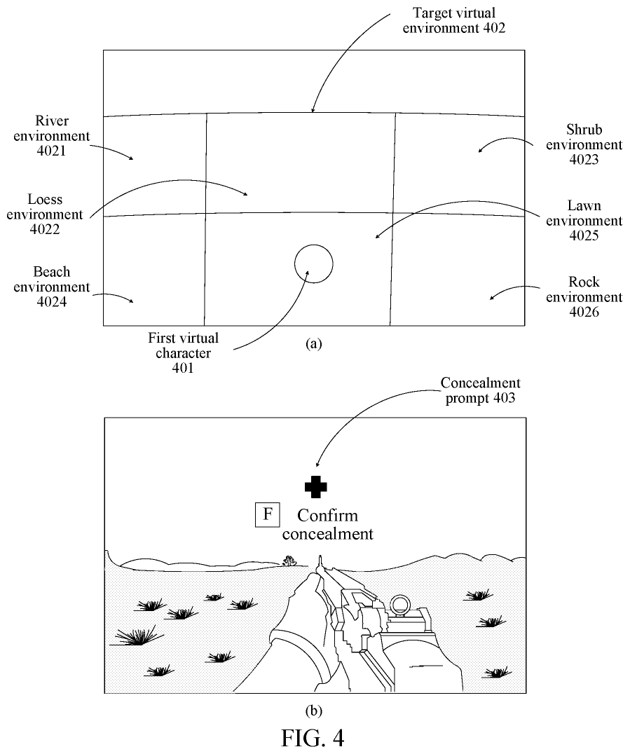

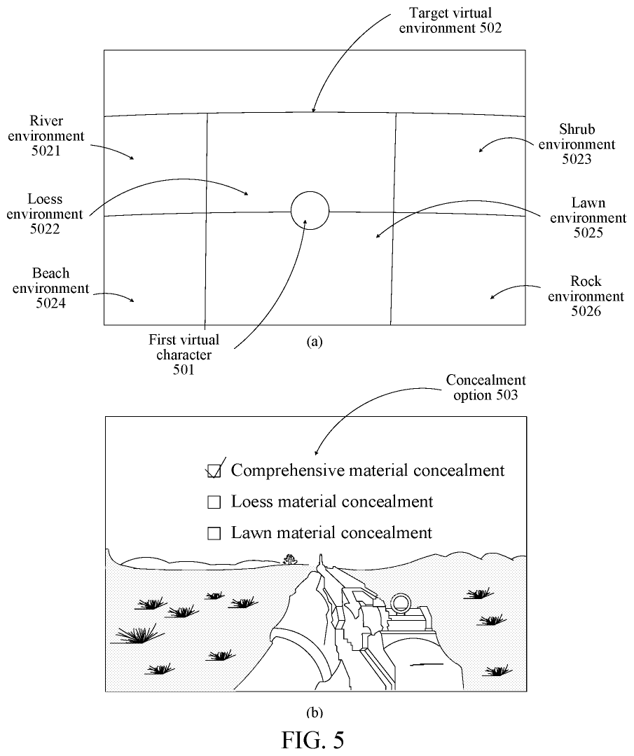

In practical application, the target virtual environment may include different environment materials. The environment materials are materials configured for describing the virtual environment, and are described below with reference to FIG. 4 and FIG. 5, respectively.

Exemplarily, FIG. 4 is a schematic diagram of triggering a concealment operation based on a surrounding environment according to an embodiment of this application. As shown in (a) in FIG. 4, 401 indicates the first virtual character, and 402 indicates the target virtual environment. The target virtual environment includes a river environment 4021, a loess environment 4022, a shrub environment 4023, a beach environment 4024, a lawn environment 4025, and a rock environment 4026. When the surrounding environment of the first virtual character is a single environment (such as a lawn environment), an interface shown in (b) in FIG. 4 is displayed. 403 indicates the concealment prompt.

Exemplarily, FIG. 5 is another schematic diagram of triggering a concealment operation based on a surrounding environment according to an embodiment of this application. As shown in (a) in FIG. 5, 501 indicates the first virtual character, and 502 indicates the target virtual environment. The target virtual environment includes a river environment 5021, a loess environment 5022, a shrub environment 5023, a beach environment 5024, a lawn environment 5025, and a rock environment 5026. When the surrounding environment of the first virtual character includes a plurality of environments (such as a loess environment and a lawn environment), an interface shown in (b) in FIG. 5 is displayed. 503 indicates a concealment option. If “Comprehensive material concealment” is selected, a character model of the first virtual character may be blended with a loess material and a lawn material. If “Loess material concealment” is selected, the character model of the first virtual character may be blended with only the loess material. If “Lawn material concealment” is selected, the character model of the first virtual character may be blended with only the lawn material.

The character model refers to a three-dimensional (3D) model of the character controlled by the player, and includes a character body model (such as limbs and hair) and an equipment model (such as clothing, a body armor, and a helmet). “In response to” in this application indicates a condition or a state upon which execution of an operation depends. When a specific condition or state is satisfied, one or more operations may be performed. These operations may be performed in real time or may be performed with a delay.
S202: The computer device displays an animation of adding a target camouflage pattern to the first virtual character within first time duration, and present a coating effect, the coating effect being determined based on a target camouflage pattern, and the target camouflage pattern being derived from the at least one type of environment material. In some embodiments, the computer device displays an animation of adding a target camouflage pattern to the first virtual character within first time duration, and the target camouflage pattern being derived from the at least one type of environment material.

In one or more embodiments, an entire coating process (namely, displaying the animation and presenting the coating effect) needs to consume the first time duration (such as 10 seconds). The first time duration represents a sum of accumulated time within a period of time. For example, the first time duration is a period of time starts in response to the concealment operation for the first virtual character or after the surrounding environment is determined, and is configured for displaying the coating process. it is assumed that the coating process requires 10 seconds (that is, it is assumed that the first time duration is 10 seconds), and it is assumed that coating start time is 15:00:00. Based on this, if the coating process is not interrupted, coating end time is 15:00:10. If the coating process is interrupted, total coating duration needs to be accumulated. For example, coating is interrupted after coating is performed for 3 seconds (that is, interruption time is 15:00:03), and coating is continued after 7 seconds. Then, coating is continued at 15:00:10, and the coating end time is 15:00:17.

In a process of performing the concealment operation, the coating effect, namely, an effect of coating, gradually appears around the periphery of a human-computer interaction interface, to simulate an effect of the first virtual character applying coating to the face of the first virtual character. The coating effect is adjusted based on the surrounding environment. The target camouflage pattern is derived from the at least one type of environment material included in the surrounding environment. That is, the coating effect is determined based on the target camouflage pattern. For example, in a loess environment, the target camouflage pattern is a loess material, and an effect of smearing loess is displayed. Meanwhile, the character material of the first virtual character (namely, a material of the character model) is gradually blended with the environment material of the surrounding environment. When the first virtual character is located in a plurality of environments, based on proportions of the environments in which the first virtual character is currently located, an environment material corresponding to an environment with a maximum proportion the environments may be used as the target camouflage pattern. Alternatively, an environment material is randomly selected from a plurality of types of environment materials as the target camouflage pattern.

The smearing animation is a dynamic effect displayed for the first virtual character in the coating process. The smearing animation may be a first-person smearing animation or a third-person smearing animation. When the player chooses to conceal the first virtual character of the player, a first-person smearing animation is displayed. Within a current field of view, if another player conceals a second virtual character (namely, a virtual character different from the first virtual character) controlled by the another player, a third-person smearing animation is displayed. In this way, the player can learn that the another player performs concealment.
S203: The computer device switches the first virtual character from an exposed display state to a concealed display state when the first time duration ends, material blending having been performed on a character material of the first virtual character in the concealed display state and the at least one type of environment material included in the surrounding environment. In some embodiments, the computer device switches the first virtual character from an exposed display state to a concealed display state when the first time duration ends, the first virtual character in the concealed display state being less visible in the target virtual environment.

In one or more embodiments, when the first time duration is reached, the first virtual character changes from the initial exposed display state to the concealed display state. The exposed display state is a state in which material blending is not performed on the character material of the virtual character and the at least one type of material included in the surrounding environment, and the concealed display state is a state in which material blending is performed on the character material of the virtual character and the at least one type of material included in the surrounding environment. For example, material blending has been performed on the character material corresponding to the first virtual character in the concealed display state and at least one type of environment material included in the surrounding environment.

Specifically, in a case, material blending may be implemented in a pixel blending manner. For example, if a pixel of the first virtual character is blue, and a pixel that is in the surrounding environment and that is closest to the pixel is green, blue and green may be blended in a specific ratio (for example, blue accounts for 20%, and green accounts for 80%) and used as a color of a pixel of the first virtual character in the concealed display state. In another case, transparency of a pixel of the first virtual character is reduced, to allow a pixel in the surrounding environment to penetrate through the pixel of the first virtual character. This achieves visual blending.

Material blending refers to an implementation of material blending. Material blending refers to a technology configured for combining different material properties in a rendering process, to create a complex and realistic visual effect. The material blending technology allows a developer to combine a plurality of types of materials in a game engine and create diversified visual effects by adjusting attributes such as a blending manner, transparency, and colors of the plurality of materials. Such a technology is usually configured for simulating a complex surface effect, such as mud, blood, and damage on a character.

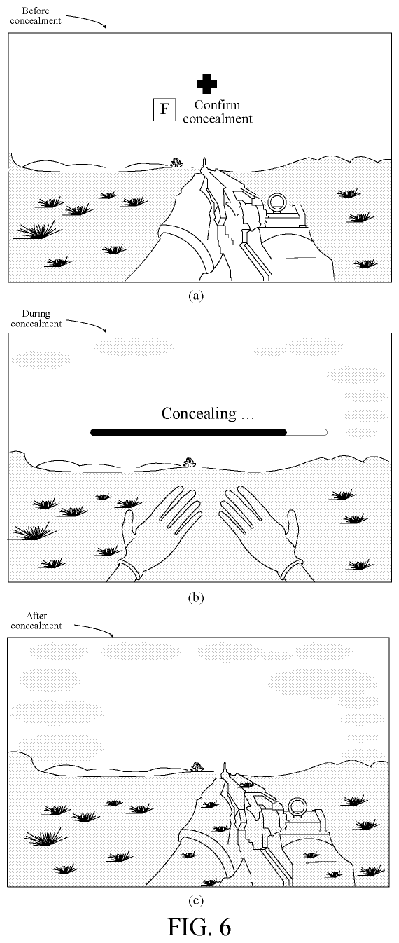

Exemplarily, FIG. 6 is a schematic diagram of a process of concealing a first-person virtual character according to an embodiment of this application. As shown in (a) in FIG. 6, from a first perspective, the first virtual character enters the target virtual environment but is not concealed. As shown in (b) in FIG. 6, from the first perspective, the concealment operation for the first virtual character is triggered. In this case, an animation and a coating effect that correspond to the first-person perspective are displayed. As shown in (c) in FIG. 6, from the first perspective, the first virtual character is switched from the exposed display state to the concealed display state.

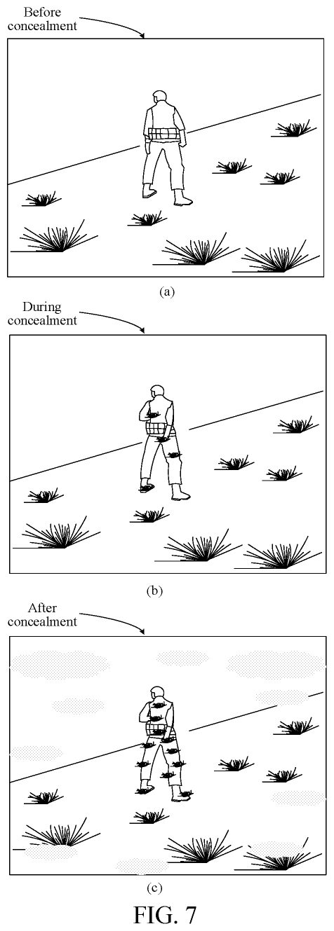

Exemplarily, FIG. 7 is a schematic diagram of a process of concealing a third-person virtual character according to an embodiment of this application. As shown in FIG. (a) in FIG. 7, from a third perspective, the first virtual character enters the target virtual environment but is not concealed. As shown in (b) in FIG. 7, from the third perspective, the concealment operation for the first virtual character is triggered. In this case, an animation and a coating effect that correspond to the third-person perspective are displayed. As shown in (c) in FIG. 7, from the third perspective, the first virtual character is switched from the exposed display state to the concealed display state.

In the embodiments of this application, the virtual character concealment method is provided. According to the method, a realistic battlefield concealment effect can be simulated, and realism of concealment is enhanced. In addition, game immersion can be improved, and a virtual character is well concealed in a current environment, to enhance a concealing effect. Furthermore, compared with a solution of developing a plurality of camouflage clothing, concealing the first virtual character based on the surrounding environment can reduce types and texture resources of camouflage clothing designed in advance, and can support more camouflage effects while reducing development costs.

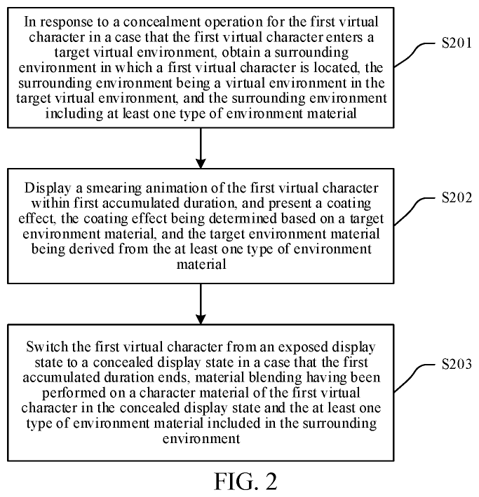

Alternatively, based on one or more embodiments corresponding to FIG. 2, in another exemplary embodiment provided in the embodiments of this application, the in response to the concealment operation for the first virtual character when the first virtual character enters the target virtual environment, obtaining the surrounding environment in which the first virtual character is located may specifically include:
displaying a concealment control after the first virtual character enters the target virtual environment; and
in response to an interaction operation for the concealment control, obtaining the surrounding environment in which the first virtual character is located.

The method may further include:
disabling display of the concealment control after the first virtual character leaves the target virtual environment.

In one or more embodiments, a manner of triggering the concealment operation is described. It can be seen from the foregoing embodiments that, when the first virtual character enters the target virtual environment, the player may trigger the concealment operation for the first virtual character through the displayed concealment control. If the first virtual character leaves the target virtual environment, the concealment control is no longer displayed.

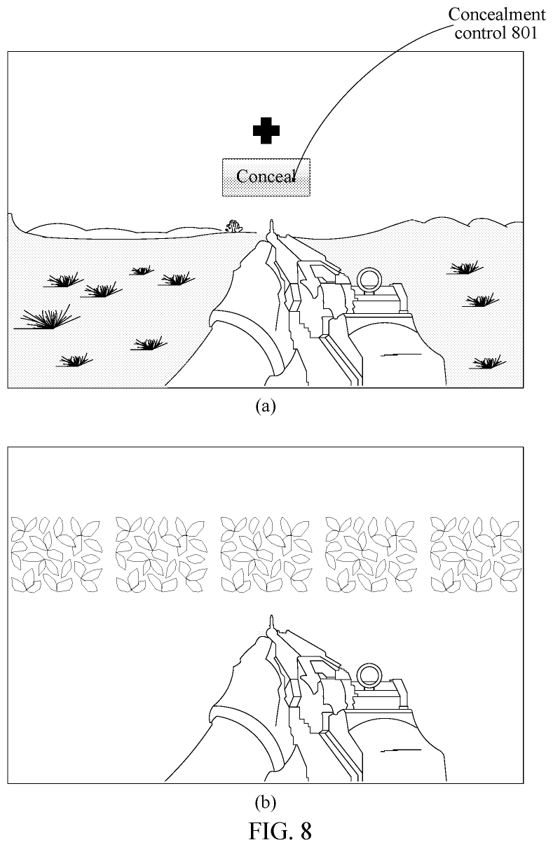

FIG. 8 is a schematic diagram of displaying a concealment control according to an embodiment of this application. As shown in (a) in FIG. 8, 801 indicates the concealment control. When the player clicks/taps the concealment control indicated by 801, the interaction operation for the concealment control is triggered. In this way, the surrounding environment in which the first virtual character is located is obtained. When the first virtual character leaves the target virtual environment, an interface shown in (b) in FIG. 8 is displayed. In this case, the concealment control is no longer displayed.

Further, in the embodiments of this application, a manner of triggering the concealment operation is provided. In the foregoing manner, the concealment control is automatically displayed or hidden based on the current position of the virtual character. In this way, a game interface is simply and clear, unnecessary element distractions are avoided, and continuity and comfort of game experience are maintained. The player may determine whether to perform the concealment operation based on whether the concealment control is displayed. In this way, a good game guidance effect is achieved.

Alternatively, based on one or more embodiments corresponding to FIG. 2, in another exemplary embodiment provided in the embodiments of this application, the in response to the concealment operation for the first virtual character when the first virtual character enters the target virtual environment, obtaining the surrounding environment in which the first virtual character is located may specifically include:
displaying a first virtual prop on a virtual backpack interface after the first virtual character enters the target virtual environment, the first virtual prop being configured to trigger the concealment operation for the first virtual character; and
in response to a use operation for the first virtual prop, obtaining the surrounding environment in which the first virtual character is located.

In one or more embodiments, another manner of triggering the concealment operation is described. It can be seen from the foregoing embodiments that, when the first virtual character enters the target virtual environment, the player may use the first virtual prop to trigger the concealment operation for the first virtual character. The first virtual prop may be stored in a virtual backpack, and the virtual backpack provides the virtual character with a space configured for storing resources such as a virtual item, a virtual prop, and virtual equipment. The virtual backpack interface is an interface configured to display the virtual backpack. The first virtual prop may be a virtual prop configured to apply coating. In a design, using the first virtual prop may improve coating efficiency, that is, reduce time required for concealment.

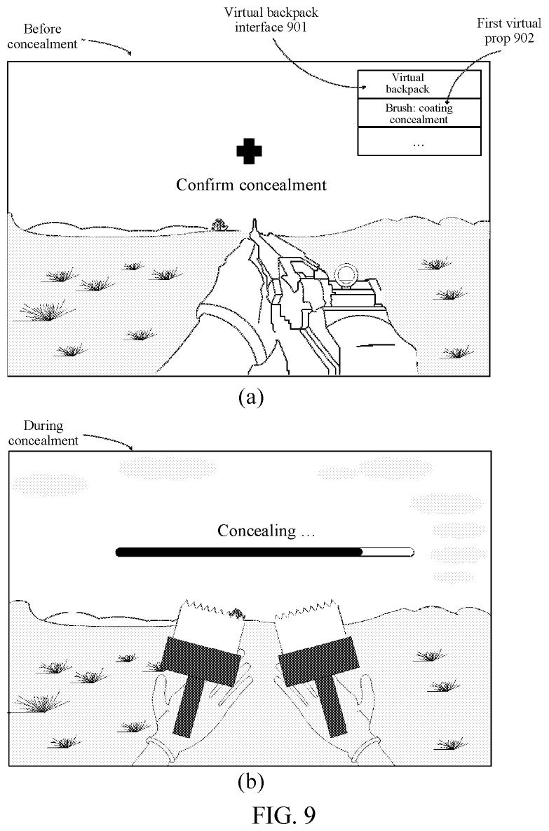

FIG. 9 is a schematic diagram of using a first virtual prop to perform concealment according to an embodiment of this application. As shown in (a) in FIG. 9, 901 indicates the virtual backpack interface, and 902 indicates the first virtual prop (such as a brush configured to apply coating). When the player clicks/taps the first virtual prop indicated by 902, the use operation for the first virtual prop is triggered. In this way, an interface shown in (b) in FIG. 9 is displayed. In this case, an animation of the first virtual character smearing while holding the first virtual prop (such as the brush) is played, and a coating effect is presented.

In practical application, after the first virtual character enters the target virtual environment, the virtual backpack interface may be automatically popped up. In another implementation, the user may manually open the virtual backpack, to display the virtual backpack interface. This is not limited herein.

Further, in the embodiments of this application, another manner of triggering the concealment operation is provided. In the foregoing manner, using the first virtual prop may simulate a realistic coating effect, and provides a different visual experience, to enhance appeal of the game.

Alternatively, based on one or more embodiments corresponding to FIG. 2, in another exemplary embodiment provided in the embodiments of this application, the in response to the concealment operation for the first virtual character when the first virtual character enters the target virtual environment, obtaining the surrounding environment in which the first virtual character is located may specifically include:
obtaining preset mode information after the first virtual character enters the target virtual environment; and
obtaining the surrounding environment in which the first virtual character is located if the preset mode information indicates that an automatic concealment mode has been enabled; or
displaying a concealment control if the preset mode information indicates that the automatic concealment mode has been disabled, and in response to an interaction operation for the concealment control, obtaining the surrounding environment in which the first virtual character is located.

In one or more embodiments, another manner of triggering the concealment operation is described. It can be seen from the foregoing embodiments that, when the player enables the automatic concealment mode, after the first virtual character controlled by the player enters the target virtual environment, a concealment function is directly enabled. The preset mode information is information indicating whether the automatic concealment mode is enabled.

Specifically, the player may select a concealment mode. If the player enables the automatic concealment mode, the preset mode information may be “Enabled”, to indicate that the automatic concealment mode has been enabled. Based on this, after the first virtual character enters the target virtual environment, the surrounding environment in which the first virtual character is located is automatically obtained, and the animation of the first virtual character is displayed within the first time duration, and the coating effect is presented. If the player disables the automatic concealment mode, the preset mode information may be “Disabled”, to indicate that the automatic concealment mode has been disabled. Based on this, after the first virtual character enters the target virtual environment, a concealment prompt or the concealment control may be displayed. In this way, the player can manually control the first virtual character to conceal itself.

Further, in the embodiments of this application, another manner of triggering the concealment operation is provided. In the foregoing manner, operation habits and game preferences of different players are satisfied. If the automatic concealment mode has been enabled, the concealment function does not need to be manually triggered. This simplifies a player operation and improves game efficiency.

Alternatively, based on one or more embodiments corresponding to FIG. 2, in another exemplary embodiment provided in the embodiments of this application, the method may further include:
performing a countdown display of remaining duration of switching the first virtual character from the exposed display state to the concealed display state within the first time duration,
the countdown display including at least one of a digital countdown and a graphical countdown.

In one or more embodiments, a manner of displaying the remaining duration of state switching is described. It can be seen from the foregoing embodiments that, to make the player clearly learn the remaining duration of switching the first virtual character from the exposed display state to the concealed display state, the countdown display may be performed in at least one form of the digital countdown and the graphical countdown.

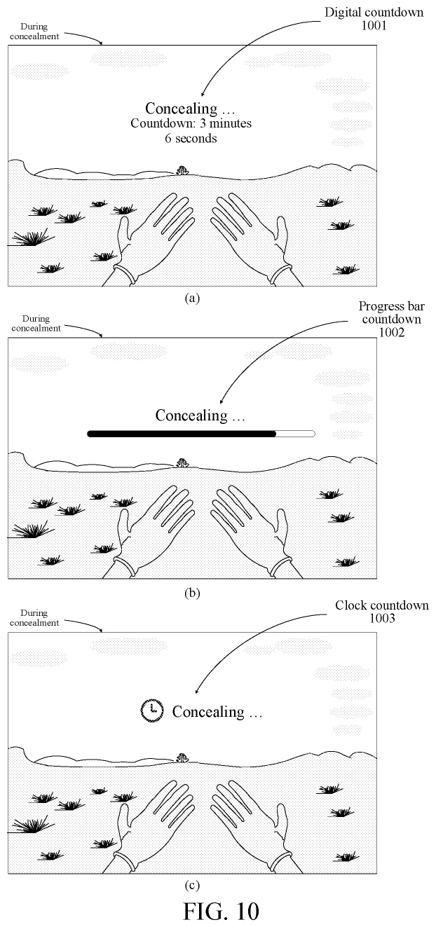

FIG. 10 is a related schematic diagram of displaying remaining duration of state switching according to an embodiment of this application. As shown in (a) in FIG. 10, 1001 indicates the remaining duration of switching the first virtual character from the exposed display state to the concealed display state that is displayed in the form of the digital countdown. As shown in (b) in FIG. 10, 1002 indicates the remaining duration of switching the first virtual character from the exposed display state to the concealed display state that is displayed in the form of a progress bar countdown. The progress bar countdown is a graphical countdown. As shown in (c) in FIG. 10, 1003 indicates the remaining duration of switching the first virtual character from the exposed display state to the concealed display state that is displayed in the form of a clock countdown. The clock countdown is a graphical countdown.

The digital countdown directly presents the remaining time in a digital form, which is simple and clear. The graphical countdown can enhance a visual effect and interactivity.

Further, in the embodiments of this application, a manner of displaying the remaining duration of state switching is provided. In the foregoing manner, the player can clearly learn the time required for switching the first virtual character to the concealed display state. This helps the player carefully plan a game and adjust an action strategy in time.

Alternatively, based on one or more embodiments corresponding to FIG. 2, in another exemplary embodiment provided in the embodiments of this application, the method may further include:
stopping display of the animation of the first virtual character in response to a concealment interruption operation for the first virtual character when the first time duration does not end, and performing a disappearing display of a coating effect corresponding to a first moment (e.g., a display of an animation of removing the target camouflage pattern from the first virtual character), the first moment being a moment at which the concealment interruption operation is triggered.

In one or more embodiments, a manner of interrupting a concealment process is described. It can be seen from the foregoing embodiment that, in a process of displaying the animation and presenting the coating effect (that is, when the first time duration does not end), the player controls the first virtual character to perform the concealment interruption operation. The concealment interruption operation is an operation of interrupting the animation, such as moving or using equipment. In this case, display of the animation is stopped, and the disappearing display of the coating effect corresponding to the first moment (namely, the moment at which the concealment interruption operation is triggered) is performed. In addition, if the countdown display of the remaining duration of switching the first virtual character from the exposed display state to the concealed display state is performed within the first time duration, the countdown of state switching is paused.

The disappearing display of the coating effect may be a process of gradually diminishing and progressively increasing in transparency over time until the coating effect disappears completely. In addition, the disappearing display of the coating effect may alternatively be an immediate disappearance.

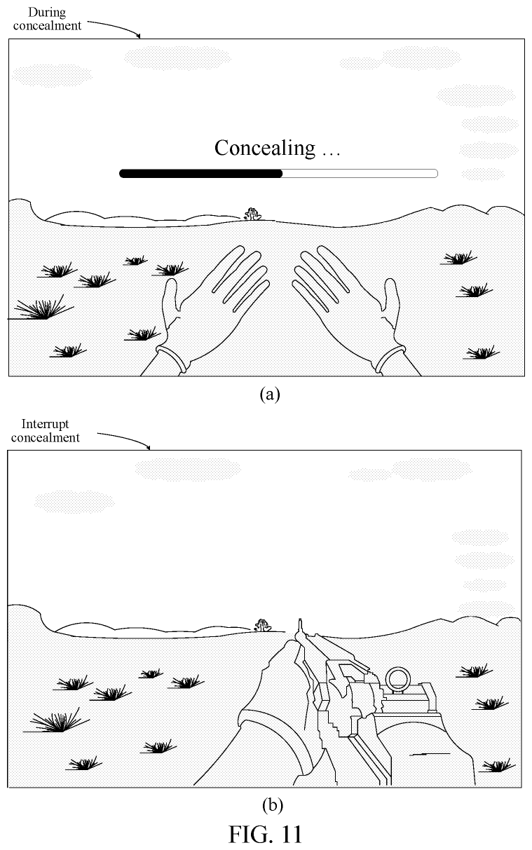

FIG. 11 is a schematic diagram of interrupting a concealment process according to an embodiment of this application. As shown in (a) in FIG. 11, the first virtual character is in a concealment process. As shown in (b) of FIG. 11, the player triggers the concealment interruption operation for the first virtual character. That is, the coating effect at the first moment is shown in the figure. It is assumed that the first time duration is 10 seconds, and the concealment interruption operation is triggered at the 6^{th} second, display of the animation of the first virtual character is immediately stopped, and the coating effect that has been generated begins to gradually fade away from the 6^{th} second.

Further, in the embodiments of this application, a manner of interrupting a concealment process is provided. In the foregoing manner, a situation in which the concealment process may be interrupted in reality can be simulated. This makes the game close to a real scene. The player needs to weigh whether to interrupt the concealment operation. This improves diversity of gameplay strategies. Meanwhile, if the concealment process is interrupted, corresponding presentation is stopped. This makes game experience smooth and natural.

Alternatively, based on one or more embodiments corresponding to FIG. 2, in another exemplary embodiment provided in the embodiments of this application, after the performing a disappearing display of a coating effect corresponding to a first moment, the method further includes: displaying the animation of the first virtual character in response to a concealment continuation operation for the first virtual character, and continuing display of a coating effect corresponding to a second moment, the second moment being a moment at which the concealment continuation operation is triggered.

In one or more embodiments, a manner of continuing a concealment process is described. It can be seen from the foregoing embodiments that, in a process of performing the concealment operation, the player may interrupt the concealment process for various reasons, and then may continue the concealment continuation operation by picking up from the coating effect at the interruption moment. The concealment continuation operation is an operation of continuing the concealment process. In this way, display of the animation and the coating effect starting from the second moment (namely, the moment at which the concealment continuation operation is triggered) are continued.

Continuing display may be understood as continuing display of the coating effect from the progress and state at the time of interruption, restoring and extending the previously interrupted coating effect, to allow display of the coating effect to be continued according to the original progress until the complete coating effect is achieved.

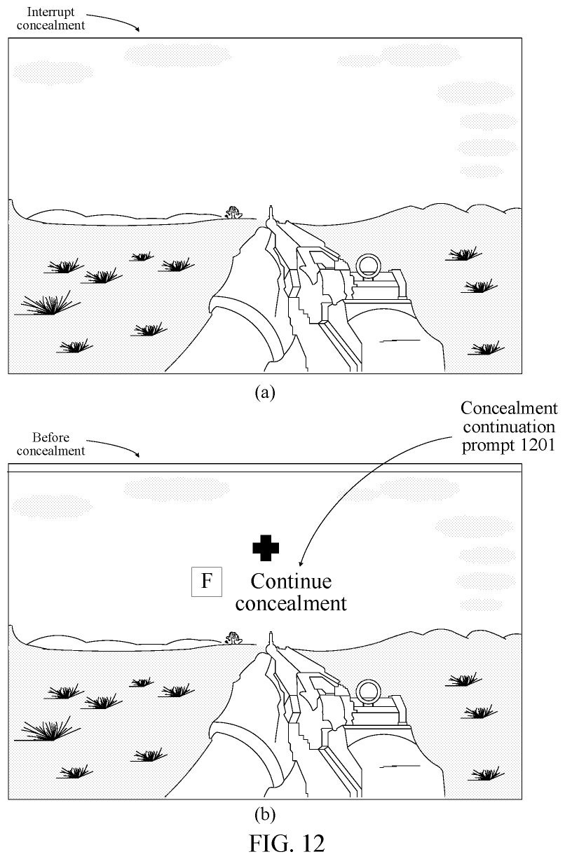

FIG. 12 is a schematic diagram of continuing a concealment process according to an embodiment of this application. As shown in (a) in FIG. 12, in this case, the player triggers the concealment interruption operation for the first virtual character. That is, the coating effect at the first moment is shown in the figure. In this way, as shown in (b) in FIG. 12, 1201 indicates a concealment continuation prompt. That is, the player may trigger the concealment continuation operation for the first virtual character through a key (such as an “F” key) on a peripheral device (such as a keyboard) based on the concealment continuation prompt indicated by 1201.

Further, in the embodiments of this application, a manner of continuing a concealment process is provided. In the foregoing manner, if the concealment process is interrupted, the concealment operation for the first virtual character may be continued from the interruption moment. In this way, a concealment effect is not returned to zero due to interruption of concealment, and continuity of game experience is maintained. Meanwhile, if concealment is interrupted due to a misoperation of the player, a corresponding remedy opportunity is further given.

Alternatively, based on one or more embodiments corresponding to FIG. 2, in another exemplary embodiment provided in the embodiments of this application, the method may further include:
determining at least one environment asset type matching the surrounding environment;
obtaining K environment asset models based on the at least one environment asset type, K being an integer greater than or equal to 1; and
sequentially adding the K environment asset models to a character model corresponding to the first virtual character within the first time duration.

In one or more embodiments, a manner of adding environment asset models is described. It can be seen from the foregoing embodiments that, after the at least one environment asset type matching the surrounding environment in which the first virtual character is located is determined, the corresponding environment asset model may be obtained based on the environment asset type. For example, if the surrounding environment is “Forest”, the corresponding environment asset type is “Shrub”. In this way, an environment asset model related to “Shrub” may be obtained.

K attachment points (for example, K is equal to 10) are preset on the character model corresponding to the first virtual character, and the environment asset models may be sequentially added to the preset attachment points on the character model. A quantity of the preset attachment points may be determined according to game requirements, and positions are preset. For example, four attachment points are set on the left shoulder of the character model, and in the concealment process, the environment asset models are sequentially placed at the four attachment points. If a plurality of environment asset types exist, environment asset models may be randomly selected and placed at corresponding attachment points.

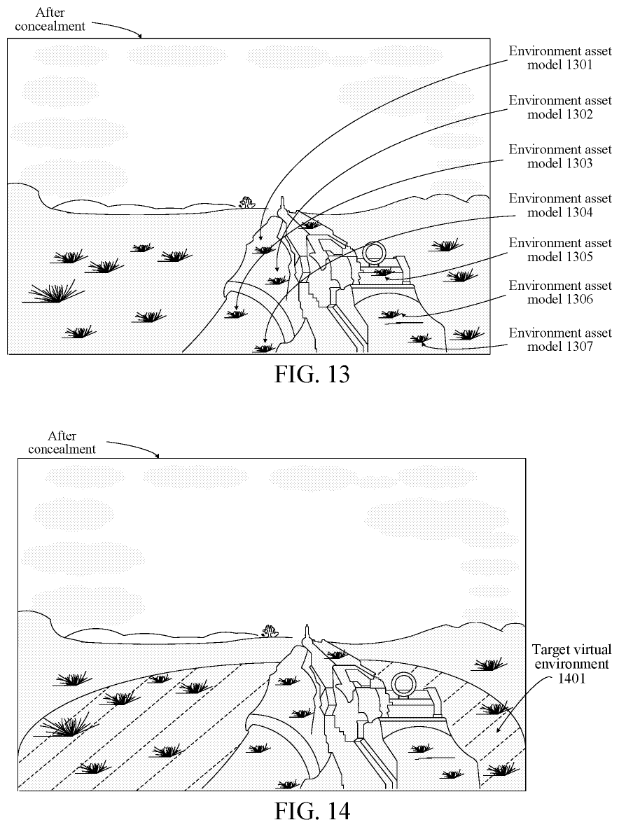

FIG. 13 is a schematic diagram of adding an environment asset type to a character model according to an embodiment of this application. As shown in the figure, it is assumed that the surrounding environment in which the first virtual character is currently located is lawn, and the environment asset type matching the surrounding environment is “Grass”. It is assumed that the character model corresponding to the first virtual character includes seven attachment points (that is, K is equal to 7). Four attachment points are set on the left arm of the first virtual character, and three attachment points are set on shooting equipment used by the first virtual character. In this way, within the first time duration, an environment asset model 1301 (namely, a small grass model A), an environment asset model 1302 (namely, a small grass model B), an environment asset model 1303 (namely, a small grass model C), and an environment asset model 1304 (namely, a small grass model D) are sequentially placed on the left arm of the character model corresponding to the first virtual character. An environment asset model 1305 (namely, a small grass model E), an environment asset model 1302 (namely, a small grass model F), and an environment asset model 1304 (namely, a small grass model G) are sequentially placed on the shooting equipment of the character model corresponding to the first virtual character.

The environment asset type is configured for describing an asset in an environment, such as a shrub in a forest environment or a lawn in a lawn environment. The environment asset model is a 3D model of an asset in a game scene, such as grass, a stone, or a branch.

In practical application, identical small grass models may be used as the environment asset models, or different small grass models may be used as the environment asset models. This is not limited herein.

Further, in the embodiments of this application, a manner of adding environment asset models is provided. In the foregoing manner, the environment asset models matching the surrounding environment are added to the character model, to make a concealment effect of the first virtual character realistic and in line with an actual environment. This increases the sense of immersion in the game world of the player.

Alternatively, based on one or more embodiments corresponding to FIG. 2, in another exemplary embodiment provided in the embodiments of this application, the method may further include:
stopping display of the animation of the first virtual character in response to a concealment interruption operation for the first virtual character when the first time duration does not end, performing a disappearing display of a coating effect corresponding to a first moment, and sequentially deleting the K environment asset models from the character model corresponding to the first virtual character, the first moment being a moment at which the concealment interruption operation is triggered.

In one or more embodiments, another manner of interrupting a concealment process is described. It can be seen from the foregoing embodiments that, in a process of displaying the animation and presenting the coating effect (that is, when the first time duration does not end), if the player controls the first virtual character to perform the concealment interruption operation (such as moving or using equipment), display of the animation is stopped, and the disappearing display of the coating effect corresponding to the first moment (namely, the moment at which the concealment interruption operation is triggered) is performed. In addition, if the countdown display of the remaining duration of switching the first virtual character from the exposed display state to the concealed display state is performed within the first time duration, the countdown of state switching is paused.

Specifically, for the character model added with the K environment asset models, the K environment asset models are sequentially deleted from the character model corresponding to the first virtual character. That is, an effect of objects falling (for example, small grass on the first virtual character falls off) is presented.

Further, in the embodiments of this application, another manner of interrupting a concealment process is provided. In the foregoing manner, the environment asset models added to the character model may fall off as the concealment operation is interrupted. In this way, a realistic effect can be achieved. In addition, this can avoid the problem of still retaining a partial concealment effect after the concealment operation is interrupted, which leads to unfair competition in the game.

Alternatively, based on one or more embodiments corresponding to FIG. 2, in another exemplary embodiment provided in the embodiments of this application, the presenting the coating effect may specifically include:
obtaining a coating interface graphic based on the target camouflage pattern; and
performing transparency reduction and range expansion on the coating interface graphic within a preset field of view, to present the coating effect.

In one or more embodiments, a manner of presenting a coating effect is described. It can be seen from the foregoing embodiments that, in a process in which the first virtual character performs the concealment operation, the coating effect gradually appears around the periphery of the visible field of view of the player. The coating effect may be achieved through the coating interface graphic, and the coating interface graphic is a pre-drawn graphic, such as a loess image or a shrub image. Therefore, if the first virtual character is located in different environments, the corresponding coating interface graphic is displayed.

Specifically, after the coating interface graphic is determined based on the target camouflage pattern, as the concealment operation is performed, the transparency of the coating interface graphic becomes progressively lower, and the range of the coating interface graphic becomes progressively larger. In this way, an effect of progressively applying coating is simulated. Transparency reduction can allow the coating to blend naturally into the environment, and range expansion can increase the coverage area of the coating effect, to making the coating effect visually prominent.

The material refers to a series of data configured for describing a display appearance of an object, and defines how the object interacts with light, shadow, a camera, and other environmental factors in a rendering process. The material determines attributes such as the color, the gloss, and the coarseness of the surface of the object, which affect a final rendering effect. However, compared to a material of a scene object model, a material of a character model has higher detail and complexity. The skin, clothing, equipment, and the like of a character require complex material and lighting models to achieve realism. Therefore, the material of the environment asset model differs significantly from the material of the character model, which makes the character stand out in the scene.

The preset field of view range may be understood as a field of view range that is preset for displaying a particular effect. An FPS game is used as an example. The preset field of view range may be the periphery of a screen, and the coating effect is displayed on the periphery of the screen, to avoid obstructing an area of a central field of view of the player and affect aiming of the player.

Further, in the embodiments of this application, a manner of presenting a coating effect is provided. In the foregoing manner, the coating effect is realistic, and the player can intuitively perceive a change of the first virtual character before and after coating. In this way, a visual effect of the game is enhanced. A realistic and optimized coating effect can enable the player to become immersed in the game scene. For example, transparency reduction can allow the coating to blend naturally into the environment, and range expansion can increase the coverage area of the coating effect, to make the coating effect visually prominent. This further enhances game immersion.

Alternatively, based on one or more embodiments corresponding to FIG. 2, in another exemplary embodiment provided in the embodiments of this application, after the controlling the first virtual character to switch from the exposed display state to the concealed display state, the method may further include: performing a disappearing display of a coating effect corresponding to a third moment within second time duration in response to a first action operation for the first virtual character, the third moment being a moment at which the first time duration ends; and
switching the first virtual character from the concealed display state to the exposed display state when the second time duration ends.

In one or more embodiments, a processing manner after concealment is completed is described. It can be seen from the foregoing embodiments that, when the first virtual character is in the concealed display state, if the player controls the first virtual character to perform the first action operation, the disappearing display of the coating effect corresponding to the third moment (namely, the moment at which the first time duration ends) is performed. This means that triggering the first action operation affects a concealment state and a concealment effect of the first virtual character. The first action operation is an action operation affecting a coating effect, and the action operation is an operation configured for controlling the virtual character to perform an action.

Specifically, the first virtual character in the concealed display state has blended into the surrounding environment. In this case, it is assumed that the player controls the first virtual character to perform the first action operation (such as standing up and moving), the concealment effect of the first virtual character begins to fade away. That is, within the second time duration, the coating effect gradually disappears until the first virtual character is restored to a state without any concealment coating effect. In this way, the first virtual character is switched from the concealed display state to the exposed display state. The second time duration represents a sum of accumulated time within a period of time. For example, the second time duration is a period of time starts in response to the first action operation, and is configured for performing the disappearing display of the coating effect.

The second time duration is equal to or not equal to the first time duration. This is not limited herein.

Further, in the embodiments of this application, a processing manner after concealment is completed is provided. In the foregoing manner, the first virtual character affects the concealment effect when performing the first action operation. In this way, the player needs to consider timing and consequences of an action, to improve diversity and richness of gameplay.

Alternatively, based on one or more embodiments corresponding to FIG. 2, in another exemplary embodiment provided in the embodiments of this application, after the controlling the first virtual character to switch from the exposed display state to the concealed display state, the method may further include:
continuously displaying a coating effect corresponding to a third moment in response to a second action operation for the first virtual character, and controlling the first virtual character to continuously remain in the concealed display state, the third moment being a moment at which the first time duration ends; and
performing a disappearing display of the coating effect corresponding to the third moment when the first virtual character leaves the target virtual environment, and switching the first virtual character from the concealed display state to the exposed display state.

In one or more embodiments, another processing manner after concealment is completed is described. It can be seen from the foregoing embodiments that, when the first virtual character is in the concealed display state, if the player controls the first virtual character to perform the second action operation, the coating effect corresponding to the third moment (namely, the moment at which the first time duration ends) is continuously displayed, and the first virtual character continuously remains in the concealed display state. This means that triggering the second action operation does not affect the concealment state and the concealment effect of the first virtual character. When the first virtual character leaves the target virtual environment, the disappearing display of the coating effect corresponding to the first virtual character is performed, and the character is controlled to switch from the concealed display state back to the exposed display state. The second action operation is an action operation that does not affect a coating effect, and the second action operation and the first action operation are different action operations.

FIG. 14 is a schematic diagram of implementing concealment based on a target virtual environment according to an embodiment of this application. As shown in the figure, the first virtual character in the concealed display state has blended into the surrounding environment. In this case, it is assumed that the player controls the first virtual character to perform the second action operation (such as moving sideways), the coating effect at the third moment (namely, the moment at which the first time duration ends) is continuously displayed, and the first virtual character continuously remains in the concealed display state. In this way, the first virtual character can still maintain good concealment, and is not easily detected by the opponent. If the first virtual character leaves the target virtual environment indicated by 1401, the disappearing display of the corresponding coating effect is gradually performed, and the character is also switched from the concealed display state back to the exposed display state.

Further, in the embodiments of this application, another processing manner after concealment is completed is provided. In the foregoing manner, the first virtual character may not affect a concealment effect when performing the second action operation. In this way, diversity and appeal of the game are increased. This helps the player take a specific strategic action without worrying about losing the concealment effect.

Alternatively, based on one or more embodiments corresponding to FIG. 2, in another exemplary embodiment provided in the embodiments of this application, after the controlling the first virtual character to switch from the exposed display state to the concealed display state, the method may further include:
performing a disappearing display of a coating effect corresponding to a third moment within third time duration if the first virtual character is in a static state within preset duration, the third moment being a moment at which the first time duration ends; and
switching the first virtual character from the concealed display state to the exposed display state when the third time duration ends.

In one or more embodiments, another processing manner after concealment is completed is provided. It can be seen from the foregoing embodiments that, if duration of remaining the first virtual character in the concealed display state reaches the preset duration (such as 5 minutes), the character material of the first virtual character needs to be restored. That is, within the third time duration, the disappearing display of the coating effect displayed at the third moment (namely, the moment at which the first time duration ends) is performed. This means that the original coating effect gradually weakens over time. When the third time duration ends, the first virtual character is switched from the concealed display state back to the exposed display state. The third time duration represents a sum of accumulated time within a period of time. For example, the third time duration is a period of time after timing of the preset duration is completed, and is configured for performing the disappearing display of the coating effect.

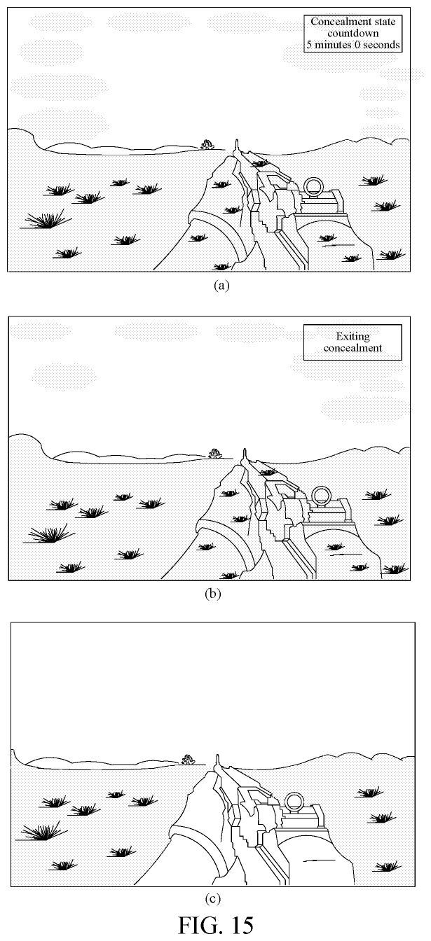

FIG. 15 is a schematic diagram of restoring to an exposed display state according to an embodiment of this application. As shown in (a) in FIG. 15, when the first virtual character is in the concealed display state, a concealment state countdown is displayed. It is assumed that the preset duration is 5 minutes, and the player can view remaining time until the preset duration ends. If the first virtual character remains static within the preset duration, after the preset duration ends, as shown in (b) in FIG. 15, the disappearing display of the coating effect is performed within the third time duration. When the third time duration ends, as shown in (c) in FIG. 15, the first virtual character is switched from the concealed display state back to the exposed display state.

The third time duration is equal to or not equal to the first time duration. This is not limited herein.

Further, in the embodiments of this application, another processing manner after concealment is completed is provided. In the foregoing manner, the first virtual character can be prevented from continuously remaining in the concealed display state because the first virtual character remains static for a long time. In this way, the player can be encouraged to actively participate in the game. In addition, fairness of the game can be enhanced, and competitive balance in the game can be maintained.

Alternatively, based on one or more embodiments corresponding to FIG. 2, in another exemplary embodiment provided in the embodiments of this application, after the in response to the concealment operation for the first virtual character, obtaining the surrounding environment in which the first virtual character is located, the method may further include:
displaying a second virtual prop on a virtual backpack interface;
shortening the first time duration in response to a use operation for the second virtual prop, to obtain fifth time duration, the fifth time duration being less than the first time duration;
displaying the animation of the first virtual character within the fifth time duration, and presenting the coating effect; and
switching the first virtual character from the exposed display state to the concealed display state when the fifth time duration ends.

In one or more embodiments, a manner of using the second virtual prop to accelerate concealment is described. It can be seen from the foregoing embodiments that, when the first virtual character enters the target virtual environment, after the first virtual character enters the concealment state through the concealment operation, the player may shorten, through the second virtual prop, the duration required for concealment. For example, the first time duration is 10 seconds. To be specific, completion of the concealment operation requires 10 seconds when the second virtual prop is not used. After the second virtual prop is used, the concealment operation may be completed within 5 seconds. The second virtual prop is configured to trigger shortening the first time duration. The fifth time duration is duration obtained after the first time duration is shortened through the second virtual prop, and the fifth time duration is less than the first time duration.

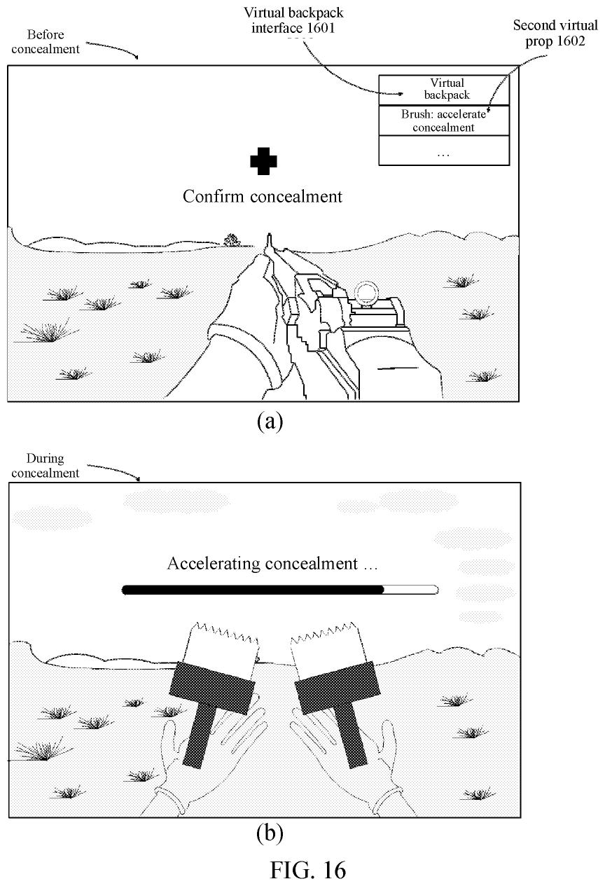

FIG. 16 is a schematic diagram of using a second virtual prop according to an embodiment of this application. As shown in (a) in FIG. 16, 1601 indicates the virtual backpack interface, and 1602 indicates the second virtual prop (such as a brush configured to accelerate concealment). When the player clicks/taps the second virtual prop indicated by 1602, the use operation for the second virtual prop is triggered. In this way, an interface shown in (b) in FIG. 16 is displayed. In this case, an animation of the first virtual character smearing while holding the second virtual prop (such as the brush) is played, and a coating effect is presented.

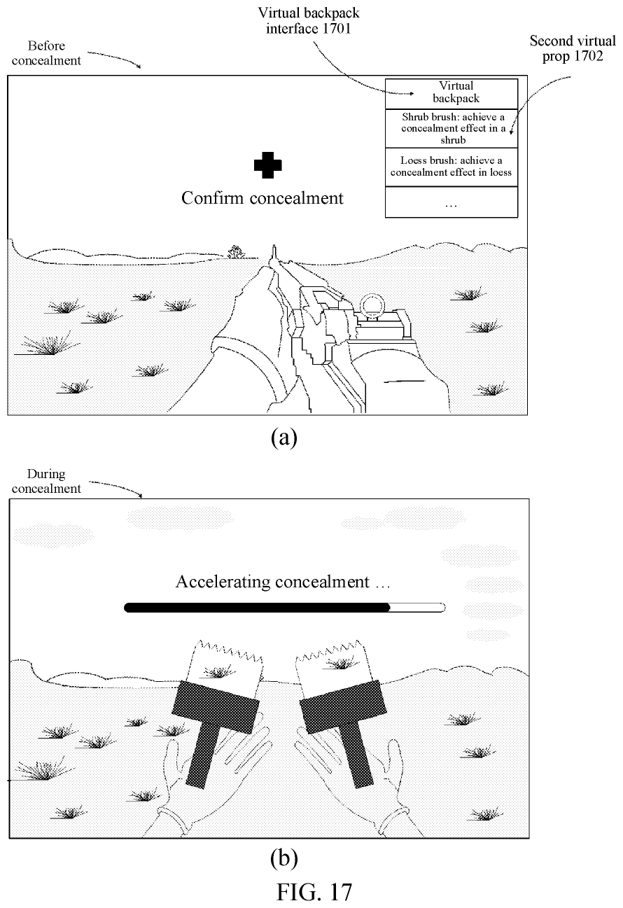

The second virtual prop may alternatively be a prop of a specified type, such as a shrub brush or a loess brush. The player may conceal himself/herself through a corresponding brush in advance, to achieve an effect of accelerating concealment in a corresponding environment. FIG. 17 is another schematic diagram of using a second virtual prop according to an embodiment of this application. As shown in (a) in FIG. 17, 1701 indicates the virtual backpack interface, and 1702 indicates the second virtual prop (such as a brush configured to accelerate concealment in a shrub environment). When the player clicks/taps the second virtual prop indicated by 1702, the use operation for the second virtual prop is triggered. In this way, an interface shown in (b) in FIG. 17 is displayed.

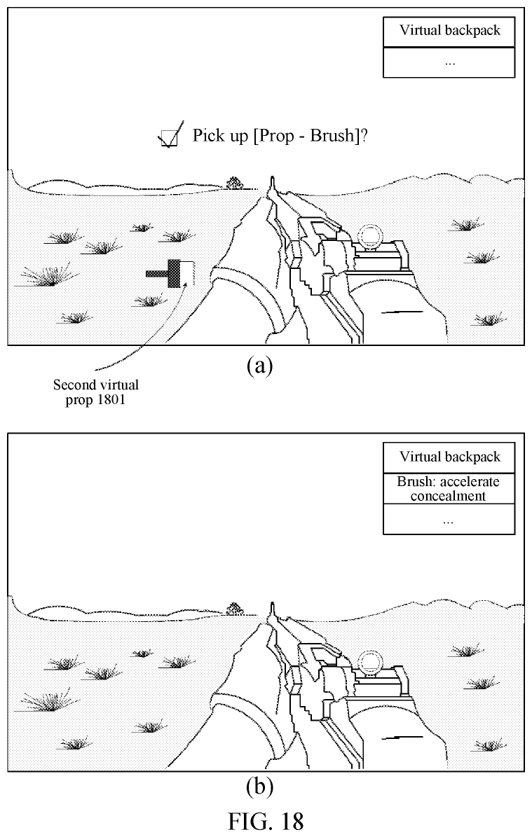

Further, FIG. 18 is a schematic diagram of obtaining a second virtual prop according to an embodiment of this application. As shown in (a) in FIG. 18, 1801 indicates a second virtual prop dropped in a game scene. When the first virtual character approaches the second virtual prop indicated by 1801, prompt information for picking up the second virtual prop pops up. After the second virtual prop is picked, as shown in (b) in FIG. 18, the second virtual prop is displayed on the virtual backpack interface.

The second virtual prop may alternatively be obtained through purchase or as a gift from a friend. This is not limited herein.

Further, in the embodiments of this application, a manner of using the second virtual prop to accelerate concealment is provided. In the foregoing manner, when the player possesses the second virtual prop, the player may use the second virtual prop to shorten the duration required for concealment. In this way, the player can well deal with an unexpected situation and a dangerous scenario that occur in the game. This makes game pace tight. The player is encouraged to actively explore the virtual environment. This increase appeal of the game.

Alternatively, based on one or more embodiments corresponding to FIG. 2, in another exemplary embodiment provided in the embodiments of this application, the method may further include:
displaying an assist concealment control if a second virtual character exists within a target range when the first virtual character enters the target virtual environment, the second virtual character and the first virtual character belonging to a same game camp;
displaying an animation of the second virtual character within fourth time duration in response to an interaction operation for the assist concealment control; and
switching the second virtual character from the exposed display state to the concealed display state when the fourth time duration ends.

In one or more embodiments, a manner of teammate-assisted concealment is described. It can be seen from the foregoing embodiments that, after the first virtual character enters the target virtual environment, if a virtual character (such as the second virtual character) belonging to a same game camp exists within the target range, the player may further control the first virtual character to assist the second virtual character in performing concealment. The target range refers to a space range constructed with the position of the first virtual character as the center, and a size and a shape of the target range may be set according to game requirements. The fourth time duration represented a sum of accumulated time within a period of time. For example, the fourth time duration is a period of time starts in response to the interaction operation for the assist concealment control, and is configured for displaying the animation of the second virtual character.

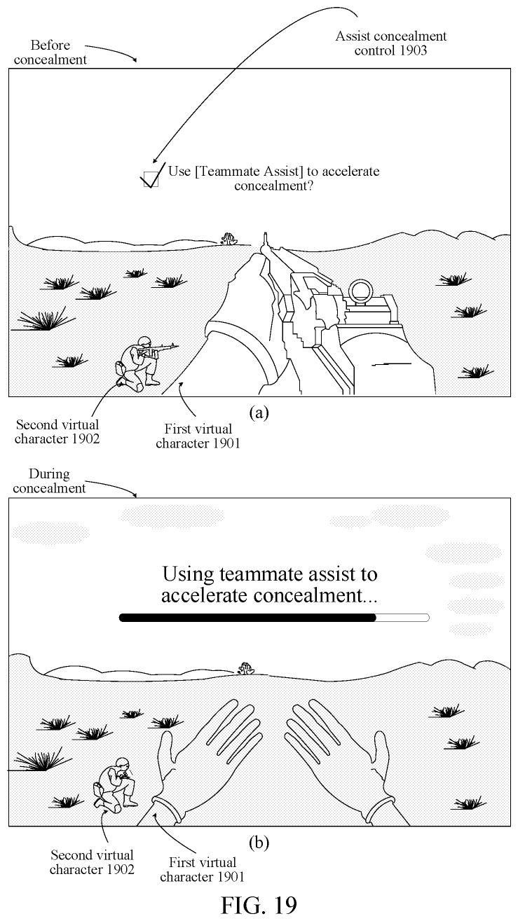

FIG. 19 is a schematic diagram of supporting teammate-assisted concealment according to an embodiment of this application. As shown in (a) in FIG. 19, 1901 indicates the first virtual character controlled by the player, and 1902 indicates the second virtual character. In this case, the second virtual character indicated by 1902 is within the target range. In this way, the assist concealment control indicated by 1903 is displayed. When the player clicks/taps the assist concealment control indicated by 1903, the interaction operation for the assist concealment control is triggered. In this way, an interface shown in (B) in FIG. 19 is displayed. Then, an animation of the first virtual character assisting the second virtual character in performing concealment is displayed within the fourth time duration (such as 8 seconds). When the fourth time duration ends, the second virtual character is switched from the exposed display state to the concealed display state.

If other game characters belonging to a same game camp as the first virtual character exist within the target range, a game character closest to the first virtual character is prioritized as the second virtual character.

Further, in the embodiments of this application, a manner of teammate-assisted concealment is provided. In the foregoing manner, cooperation and mutual assistance among players of the same faction are promoted, to enhance team synergy and battle power. The player can flexibly choose, based on a battlefield situation, whether to request a teammate to assist in performing concealment. In this way, diversity of strategy designs is increased, appeal of the game is enhanced, and communication and cooperation between players are promoted.

Alternatively, based on one or more embodiments corresponding to FIG. 2, in another exemplary embodiment provided in the embodiments of this application, the displaying the animation of the first virtual character within the first time duration, and presenting the coating effect may specifically include:
displaying the animation of the first virtual character from a first-person perspective within the first time duration, and presenting the coating effect; and
displaying the animation of the first virtual character from a third-person perspective in response to a perspective switching operation for the first virtual character, and presenting the coating effect;
or
the displaying the animation of the first virtual character within the first time duration, and presenting the coating effect may specifically include:
displaying the animation of the first virtual character from a third-person perspective within the first time duration, and presenting the coating effect; and
displaying the animation of the first virtual character from a first-person perspective in response to a perspective switching operation for the first virtual character, and presenting the coating effect.

In one or more embodiments, a manner of switching a perspective to display the animation is described. It can be seen from the foregoing embodiments that, in the process of concealing the first virtual character, the player may further switch a current perspective.

Exemplarily, the player adopts the first-person perspective. In this case, after the player triggers the concealment operation for the first virtual character, the animation of the first virtual character is displayed from the first-person perspective within the first time duration, and the coating effect is presented from the first-person perspective. The smearing animation displayed from the first-person perspective is referred to as a first-person smearing animation. Based on this, if the player triggers the perspective switching operation for the first virtual character, display of the animation of the first virtual character is switched to the third-person perspective, and the corresponding coating effect is presented from the third-person perspective. The smearing animation displayed from the third-person perspective is referred to as a third-person smearing animation.

Exemplarily, the player adopts the third-person perspective. In this case, after the player triggers the concealment operation for the first virtual character, the animation of the first virtual character is displayed from the third-person perspective within the first time duration, and the coating effect is presented from the third-person perspective. Based on this, if the player triggers the perspective switching operation for the first virtual character, display of the animation of the first virtual character is switched to the first-person perspective, and the corresponding coating effect is presented from the first-person perspective.

The coating effect presented from the first-person perspective may display a smearing effect around the periphery of the screen, and the coating effect presented from the third-person perspective may display a smearing effect on the body of the first virtual character.

Further, in the embodiments of this application, a manner of switching a perspective to display the animation is provided. In the foregoing manner, the player can switch the perspective in the process of concealing the first virtual character. In this way, the player can view a blending situation between the coating effect and the surrounding environment, to enhance game immersion.

Alternatively, based on one or more embodiments corresponding to FIG. 2, in another exemplary embodiment provided in the embodiments of this application, before the controlling the first virtual character to switch from the exposed display state to the concealed display state when the first time duration ends, the method may further include:
obtaining a preset pixel corresponding to each type of environment material of the at least one type of environment material; and
separately obtaining, based on N pixels included in the character material of the first virtual character, a to-be-blended environment material corresponding to each pixel, the to-be-blended environment material being an environment material closest to the pixel, and N being an integer greater than 1;
determining a preset pixel corresponding to each pixel based on the to-be-blended environment material corresponding to each pixel; and
performing material blending on each pixel and the corresponding preset pixel.

In one or more embodiments, a manner of blending the character material with the environment material is described. It can be seen from the foregoing embodiments that, first, the preset pixel used when blending is performed on each environment material is determined (for example, a preset pixel used by a loess material is a yellow pixel). Then, the character material is analyzed, to find the environment material closest to each pixel. In this way, the to-be-blended environment material corresponding to each pixel is obtained. The to-be-blended environment material corresponding to the pixel is the environment material closest to the pixel. Finally, material blending is performed on each pixel of the first virtual character and the corresponding preset pixel based on the to-be-blended environment material.

Specifically, it is assumed that the first virtual character is located in a forest environment, and environment materials included in the surrounding environment include a tree material, a lawn material, and a mud material. A pixel of the character material is used as an example, and an environment material closest to the pixel that is determined through calculation is a lawn material. Then, a preset pixel (such as a preset green pixel) corresponding to the lawn material is obtained. In this way, material blending is performed on the pixel of the character material and the preset pixel of the lawn material in a specific ratio, to make the pixel of the character material close to the surrounding environment. The blending ratio may be flexibly adjusted according to a game design. This is not limited herein. Similar processing is performed on the N pixels included in the character material, to obtain an effect after material blending.

Further, in the embodiments of this application, a manner of blending the character material with the environment material is provided. In the foregoing manner, different types of environment materials are accurately blended. In this way, a natural material blending effect can be achieved. Meanwhile, the pixels in the character material are blended with preset pixels corresponding to adjacent environment materials. In this way, blending efficiency can be enhanced, and material blending can be completed when a small quantity of processing resources are consumed.

Alternatively, based on one or more embodiments corresponding to FIG. 2, in another exemplary embodiment provided in the embodiments of this application, before the controlling the first virtual character to switch from the exposed display state to the concealed display state when the first time duration ends, the method may further include:
obtaining pixels corresponding to each type of environment material of the at least one type environment material;
separately obtaining, based on N pixels included in the character material of the first virtual character, a to-be-blended pixel corresponding to each pixel, the to-be-blended pixel being a pixel in the environment material, and N being an integer greater than 1; and
performing material blending on each pixel and the corresponding to-be-blended pixel.

In one or more embodiments, another manner of blending the character material with the environment material is described. It can be seen from the foregoing embodiments that, first, the character material is analyzed, to find the to-be-blended pixel that is closest and corresponds to each pixel in the character material. The to-be-blended pixel is a pixel included in the environment material. In this way, each pixel of the first virtual character is blended with the corresponding to-be-blended pixel.

Specifically, it is assumed that the first virtual character is located in a snowy environment, and environment materials included in the surrounding environment include a snowflake material and an ice material. A pixel of the character material is used as an example, and a to-be-blended pixel closest to the pixel is determined through calculation. Material blending is performed on the pixel of the character material and the to-be-blended pixel in a specific ratio, to make the pixel of the character material close to the surrounding environment. The blending ratio may be flexibly adjusted according to a game design. This is not limited herein. Similar processing is performed on the N pixels included in the character material, to obtain an effect after material blending.

Further, in the embodiments of this application, another manner of blending the character material with the environment material is provided. In the foregoing manner, when device performance permits, the pixels corresponding to the character material are respectively blended with the pixels in the environment material. In this way, a natural material blending effect can be achieved, and game reality and immersion can be enhanced.

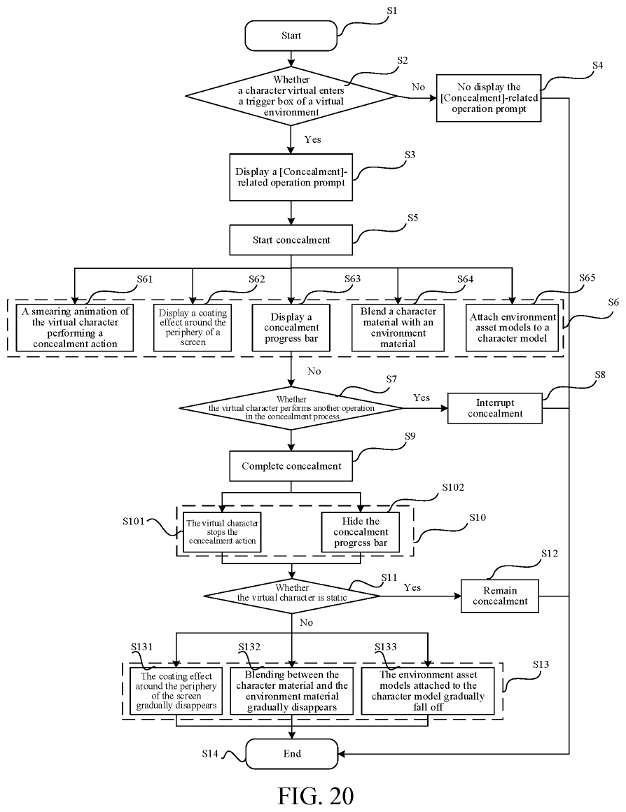

With reference to the foregoing embodiments, an overall procedure of the virtual character concealment method is described below. For ease of understanding, refer to 20. FIG. 20 is a schematic overall flowchart of a virtual character concealment method according to an embodiment of this application. As shown in the figure, specifically:
Operation S1: Start a game, and create a trigger box in a specific virtual environment, for example, create a trigger box in a mud environment or create a trigger box in a shrub environment. The trigger box is an area capable of continuously detecting events and triggering a signal when detecting occurrence of an event. For example, after a player enters the area of the trigger box, a signal indicating that the player enters the trigger box is transmitted.
Operation S2: Detect whether a virtual character enters the trigger box of the virtual environment, and perform operation S3 if the virtual character enters the trigger box of the virtual environment, or perform operation S4 if the virtual character does not enter the trigger box of the virtual environment.
Operation S3: Transmit a signal a terminal used by a player if it is detected that the virtual character enters the trigger box of the virtual environment, and then, display a concealment prompt on the terminal.
Operation S4: The terminal used by the player does not display the concealment prompt if it is detected that the virtual character does not enter the trigger box of the virtual environment.
Operation S5: The player may trigger a concealment operation for the currently controlled virtual character when the concealment prompt is displayed, to start a concealment process.
Operation S6: Perform a concealment-related action. Operation S61: Play a self-coating action of the virtual character, a specific action being determined according to a specific game design. For example, an action of the virtual character smearing toward a camera is played in a first-person game, or an action of the virtual character smearing toward the body of the virtual character is played in a third-person game. Operation S62: A coating effect gradually appears around the periphery of a field of view of the player. Operation S63: Display a progress bar that gradually fills from left to right according to execution time of a concealment function, descriptive text “Concealing . . . ” being further displayed above the progress bar. Operation S64: Gradually blend a character material of the virtual character with an environment material of a surrounding environment. Operation S65: Attach environment asset models to a character model.
Operation S7: Determine whether the virtual character performs another operation (such as moving or using equipment) in the concealment process, and perform operation S8 is the virtual character performs the another operation, or perform operation S9 is the virtual character does not perform the another operation.
Operation S8: Interrupt the concealment process if the virtual character performs the another operation in the concealment process. The another operation refers to an action operation other than a second action operation, such as a first action operation.
Operation S9: Continue concealment until concealment is completed if the virtual character does not perform the another operation in the concealment process.
Operation S10: Display related content after concealment of the virtual character is completed. Operation S101: Stop display of an animation of the virtual character. Operation S102: Hide the concealment progress bar.
Operation S11: Determine whether the virtual character is in a static state, and perform operation S12 if the virtual character is in the static state, or perform operation S13 is the virtual character is not in the static state.
Operation S12: Remain concealment if the virtual character is in the static state.
Operation S13: Perform a related operation if the virtual character is not in the static state. Operation S131: The coating effect displayed around the periphery of a screen gradually disappears. Operation S132: A blending effect between the character material of the virtual character and the environment material gradually disappears, and slowly restore the virtual character to the original character material. Operation S133: The environment asset models on the character model gradually falls off in the restoration process.
Operation S14: End the current concealment procedure.

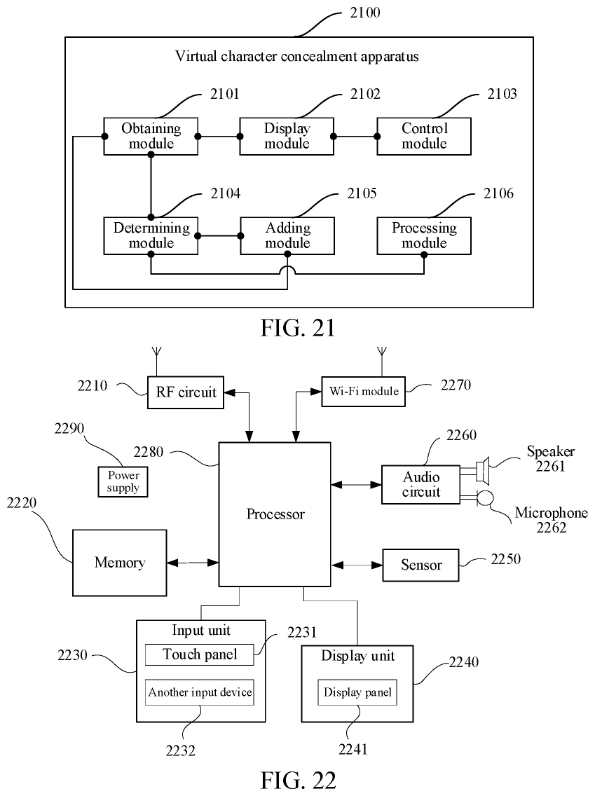

A virtual character concealment apparatus of this application is described below in detail. FIG. 21 is a schematic diagram of an embodiment of a virtual character concealment apparatus according to an embodiment of this application. A virtual character concealment apparatus 2100 includes:
an obtaining module 2101, configured to: in response to a concealment operation for the first virtual character when the first virtual character enters a target virtual environment, obtain a surrounding environment in which a first virtual character is located, the surrounding environment being a virtual environment in the target virtual environment, and the surrounding environment including at least one type of environment material;
a display module 2102, configured to display an animation of adding a target camouflage pattern to the first virtual character within first time duration, and present a coating effect, the coating effect being determined based on a target camouflage pattern, and the target camouflage pattern being derived from the at least one type of environment material; and
a control module 2103, configured to switch the first virtual character from an exposed display state to a concealed display state when the first time duration ends, material blending having been performed on a character material of the first virtual character in the concealed display state and the at least one type of environment material included in the surrounding environment.

Alternatively, based on the embodiment corresponding to FIG. 21, in another embodiment of the virtual character concealment apparatus 2100 provided in the embodiments of this application,
the obtaining module 2101 is specifically configured to display a concealment control after the first virtual character enters the target virtual environment; and
in response to an interaction operation for the concealment control, obtain the surrounding environment in which the first virtual character is located; and
the display module 2102 is further configured to disable display of the concealment control after the first virtual character leaves the target virtual environment.

Alternatively, based on the embodiment corresponding to FIG. 21, in another embodiment of the virtual character concealment apparatus 2100 provided in the embodiments of this application,
the obtaining module 2101 is specifically configured to display a first virtual prop on a virtual backpack interface after the first virtual character enters the target virtual environment, the first virtual prop being configured to trigger the concealment operation for the first virtual character; and
in response to a use operation for the first virtual prop, obtain the surrounding environment in which the first virtual character is located.

Alternatively, based on the embodiment corresponding to FIG. 21, in another embodiment of the virtual character concealment apparatus 2100 provided in the embodiments of this application,
the obtaining module 2101 is specifically configured to obtain preset mode information after the first virtual character enters the target virtual environment; and
obtain the surrounding environment in which the first virtual character is located if the preset mode information indicates that an automatic concealment mode has been enabled; or
display a concealment control if the preset mode information indicates that the automatic concealment mode has been disabled, and in response to an interaction operation for the concealment control, obtain the surrounding environment in which the first virtual character is located.

Alternatively, based on the embodiment corresponding to FIG. 21, in another embodiment of the virtual character concealment apparatus 2100 provided in the embodiments of this application,
the display module 2102 is further configured to perform a countdown display of remaining duration of switching the first virtual character from the exposed display state to the concealed display state within the first time duration,
the countdown display including at least one of a digital countdown and a graphical countdown.

Alternatively, based on the embodiment corresponding to FIG. 21, in another embodiment of the virtual character concealment apparatus 2100 provided in the embodiments of this application,
the display module 2102 is further configured to stop display of the animation of the first virtual character in response to a concealment interruption operation for the first virtual character when the first time duration does not end, and perform a disappearing display of a coating effect corresponding to a first moment, the first moment being a moment at which the concealment interruption operation is triggered.

Alternatively, based on the embodiment corresponding to FIG. 21, in another embodiment of the virtual character concealment apparatus 2100 provided in the embodiments of this application,
the display module 2102 is further configured to display the animation of the first virtual character in response to a concealment continuation operation for the first virtual character after the disappearing display of the coating effect corresponding to the first moment is performed, and continue display of a coating effect corresponding to a second moment, the second moment being a moment at which the concealment continuation operation is triggered.

Alternatively, based on the embodiment corresponding to FIG. 21, in another embodiment of the character virtual concealment apparatus 2100 provided in the embodiments of this application, the virtual character concealment apparatus 2100 further includes a determining module 2104 and an adding module 2105.

The determining module 2104 is configured to determine at least one environment asset type matching the surrounding environment.

The obtaining module 2101 is further configured to obtain K environment asset models based on the at least one environment asset type, K being an integer greater than or equal to 1.

The adding module 2105 is configured to sequentially add the K environment asset models to a character model corresponding to the first virtual character within the first time duration.

Alternatively, based on the embodiment corresponding to FIG. 21, in another embodiment of the virtual character concealment apparatus 2100 provided in the embodiments of this application,
the display module 2102 is further configured to stop display of the animation of the first virtual character in response to a concealment interruption operation for the first virtual character when the first time duration does not end, perform a disappearing display of a coating effect corresponding to a first moment, and sequentially delete the K environment asset models from the character models corresponding to the first virtual character, the first moment being a moment at which the concealment interruption operation is triggered.

Alternatively, based on the embodiment corresponding to FIG. 21, in another embodiment of the virtual character concealment apparatus 2100 provided in the embodiments of this application,
the display module 2102 is specifically configured to obtain a coating interface graphic based on the target camouflage pattern; and
perform transparency reduction and range expansion on the coating interface graphic within a preset field of view, to present the coating effect.

Alternatively, based on the embodiment corresponding to FIG. 21, in another embodiment of the virtual character concealment apparatus 2100 provided in the embodiments of this application,
the display module 2102 is further configured to perform a disappearing display of a coating effect corresponding to a third moment within second time duration in response to a first action operation for the first virtual character after the first virtual character is switched from the exposed display state to the concealed display state, the third moment being a moment at which the first time duration ends; and
the control module 2103 is further configured to switch the first virtual character from the concealed display state to the exposed display state when the second time duration ends.

Alternatively, based on the embodiment corresponding to FIG. 21, in another embodiment of the virtual character concealment apparatus 2100 provided in the embodiments of this application,
the display module 2102 is further configured to continuously display a coating effect corresponding to a third moment in response to a second action operation for the first virtual character after the first virtual character is switched from the exposed display state to the concealed display state, and control the first virtual character to continuously remain in the concealed display state, the third moment being a moment at which the first time duration ends; and
the control module 2103 is further configured to perform a disappearing display of the coating effect corresponding to the third moment when the first virtual character leaves the target virtual environment, and switch the first virtual character from the concealed display state to the exposed display state.

Alternatively, based on the embodiment corresponding to FIG. 21, in another embodiment of the virtual character concealment apparatus 2100 provided in the embodiments of this application,
the display module 2102 is further configured to perform a disappearing display of a coating effect corresponding to a third moment within third time duration if the first virtual character is in a static state within preset duration after the first virtual character is switched from the exposed display state to the concealed display state, the third moment being a moment at which the first time duration ends; and
the control module 2103 is further configured to switch the first virtual character from the concealed display state to the exposed display state when the third time duration ends.

Alternatively, based on the embodiment corresponding to FIG. 21, in another embodiment of the virtual character concealment apparatus 2100 provided in the embodiments of this application,
the display module 2102 is further configured to display a second virtual prop on a virtual backpack interface after the surrounding environment in which the first virtual character is located is obtained in response to the concealment operation for the first virtual character, display the animation of the first virtual character within fifth time duration, and present the coating effect; and
the control module 2103 is further configured to switch the first virtual character from the exposed display state to the concealed display state when the fifth time duration ends.

Alternatively, based on the embodiment corresponding to FIG. 21, in another embodiment of the virtual character concealment apparatus 2100 provided in the embodiments of this application,
the display module 2102 is further configured to display an assist concealment control if a second virtual character exists within a target range when the first virtual character enters the target virtual environment, the second virtual character and the first virtual character belonging to a same game camp;
the display module 2102 is further configured to display an animation of the second virtual character within fourth time duration in response to an interaction operation for the assist concealment control; and
the control module 2103 is further configured to switch the second virtual character from the exposed display state to the concealed display state when the fourth time duration ends.

Alternatively, based on the embodiment corresponding to FIG. 21, in another embodiment of the virtual character concealment apparatus 2100 provided in the embodiments of this application,
the display module 2102 is specifically configured to display the animation of the first virtual character from a first-person perspective within the first time duration, and present the coating effect; and
display the animation of the first virtual character from a third-person perspective in response to a perspective switching operation for the first virtual character, and present the coating effect;
or
the display module 2102 is specifically configured to display the animation of the first virtual character from a third-person perspective within the first time duration, and present the coating effect; and
display the animation of the first virtual character from a first-person perspective in response to a perspective switching operation for the first virtual character, and present the coating effect.

Alternatively, based on the embodiment corresponding to FIG. 21, in another embodiment of the virtual character concealment apparatus 2100 provided in the embodiments of this application, the virtual character concealment apparatus 2100 further includes a processing module 2106.

The obtaining module 2101 is further configured to obtain a preset pixel corresponding to each type of environment material of the at least one type of environment material before the first virtual character is switched from the exposed display state to the concealed display state when the first time duration ends.

The obtaining module 2101 is further configured to separately obtain, based on N pixels included in the character material of the first virtual character, a to-be-blended environment material corresponding to each pixel, the to-be-blended environment material being an environment material closest to the pixel, and N being an integer greater than 1.

The determining module 2104 is further configured to determine a preset pixel corresponding to each pixel based on the to-be-blended environment material corresponding to each pixel.

The processing module 2106 is configured to perform material blending on each pixel and the corresponding preset pixel.

Alternatively, based on the embodiment corresponding to FIG. 21, in another embodiment of the virtual character concealment apparatus 2100 provided in the embodiments of this application,
the obtaining module 2101 is further configured to obtain pixels corresponding to each type of environment material of the at least one type of environment material before the first virtual character is switched from the exposed display state to the concealed display state when the first time duration ends;
the obtaining module 2101 is further configured to separately obtain, based on N pixels included in the character material of the first virtual character, a to-be-blended pixel corresponding to each pixel, the to-be-blended pixel being a pixel in the environment material, and N being an integer greater than 1; and
the processing module 2106 is further configured to perform material blending on each pixel and the corresponding to-be-blended pixel.

The embodiments of this application further provide a terminal, as shown in FIG. 22. For ease of description, only parts related to the embodiments of this application are shown. For specific technical details that are not disclosed, refer to the part of the method embodiments of this application. In the embodiments of this application, a description is made by using an example in which the terminal is a mobile phone.

FIG. 22 is a block diagram of a partial structure of a mobile phone related to a terminal according to an embodiment of this application. Refer to FIG. 22. The mobile phone includes components such as a radio frequency (RF) circuit 2210, a memory 2220, an input unit 2230, a display unit 2240, a sensor 2250, an audio circuit 2260, a wireless fidelity (Wi-Fi) module 2270, a processor 2280, and a power supply 2290. A person skilled in the art may understand that the structure of the mobile phone shown in FIG. 22 does not constitute a limitation on the mobile phone. The mobile phone may include more or fewer components than those shown in the figure, or some components may be combined, or a different component arrangement may be adopted.

The components of the mobile phone are described in detail below with reference to FIG. 22.

The RF circuit 2210 may be configured to receive and transmit a signal during information reception and transmission or calling. Particularly, after receiving downlink information from a base station, the RF circuit transmits the information to the processor 2280 for processing. In addition, the RF circuit transmits related uplink data to the base station.

The memory 2220 may be configured to store a software program and a module. The processor 2280 runs the software program and the module that are stored in the memory 2220, to perform various functional applications and data processing of the mobile phone.

The input unit 2230 may be configured to receive input digit or character information, and generate a key signal input related to user settings and function control of the mobile phone. Specifically, the input unit 2230 may include a touch panel 2231 and another input device 2232. The touch panel 2231, also referred to as a touchscreen, may collect a touch operation of a user on or near the touch panel (such as an operation of the user on or near the touch panel 2231 using any suitable object or attachment, such as a finger or a stylus), and drive a corresponding connection apparatus according to a preset program. In an embodiment, the touch panel 2231 may include two parts: a touch detection apparatus and a touch controller. The touch detection apparatus detects a touch position of the user, detects a signal generated by the touch operation, and transmits the signal to the touch controller. The touch controller receives touch information from the touch detection apparatus, converts the touch information into touch point coordinates, and then transmits the touch point coordinates to the processor 2280. Moreover, the touch controller can receive a command transmitted by the processor 2280 and execute the command. In addition, the touch panel 2231 may be a resistive, capacitive, infrared, or surface sound wave type touch panel. In addition to the touch panel 2231, the input unit 2230 may further include the another input device 2232. Specifically, the another input device 2232 may include, but is not limited to, one or more of a physical keyboard, a functional key (such as a volume control key and a switch key), a track ball, a mouse, and a joystick, and the like.

The display unit 2240 may be configured to display information inputted by the user or information provided for the user, as well as various menus of the mobile phone. The display unit 2240 may include a display panel 2241. In an embodiment, the display panel 2241 may be configured in the form of a liquid crystal display (LCD), an organic light-emitting diode (OLED), or the like. Further, the touch panel 2231 may cover the display panel 2241. After detecting a touch operation on or near the touch panel, the touch panel 2231 transmits the touch operation to the processor 2280, to determine a type of a touch event. Then, the processor 2280 provides a corresponding visual output on the display panel 2241 based on the type of the touch event. Although in FIG. 22, the touch panel 2231 and the display panel 2241 are used as two separate components to implement input and input functions of the mobile phone, in some embodiments, the touch panel 2231 and the display panel 2241 may be integrated to implement the input and output functions of the mobile phone.

The mobile phone may further include at least one sensor 2250, such as an optical sensor, a motion sensor, and another sensor. Specifically, the optical sensor may include an ambient light sensor and a proximity sensor. The ambient light sensor may adjust luminance of the display panel 2241 based on brightness of the ambient light. The proximity sensor may switch off the display panel 2241 and/or backlight when the mobile phone is moved to an ear. As one type of motion sensor, an accelerometer sensor may detect magnitudes of accelerations in various directions (which generally are three axes), may detect a magnitude and a direction of the gravity when static, and may be applied to applications of identifying a posture of the mobile phone (such as landscape/portrait switching, a related game, and posture calibration of a magnetometer), and a vibration identification-related function (such as a pedometer and knock). Other sensors, such as a gyroscope, a barometer, a hygrometer, a thermometer, and an infrared sensor, may be further configured on the mobile phone. Details are not described herein again.

The audio circuit 2260, a speaker 2261, and a microphone 2262 may provide audio interfaces between the user and the mobile phone. The audio circuit 2260 may convert received audio data into an electric signal and transmit the electric signal to the speaker 2261. The speaker 2261 converts the electric signal into a sound signal and outputs the sound signal. In addition, the microphone 2262 converts a collected sound signal into an electrical signal. After receiving the electrical signal, the audio circuit 2260 converts the electrical signal into audio data, and then outputs the audio data. After being processed by the processor 2280, the audio data is transmitted through the RF circuit 2210 to, for example, another mobile phone, or the audio data is outputted to the memory 2220 for further processing.

Wi-Fi is a short-range wireless transmission technology. The mobile phone may assist, through the Wi-Fi module 2270, the user in receiving and transmitting an email, browsing a web page, accessing streaming media, and the like. It provides the user with wireless broadband Internet access. Although FIG. 22 shows the Wi-Fi module 2270, the Wi-Fi module is not a necessary component of the mobile phone. When required, the Wi-Fi module may be omitted as long as the scope of the essence of this application is not changed.

The processor 2280 is a control center of the mobile phone, and is connected to various parts of the entire mobile phone via various interfaces and lines. The processor implements various functions of the mobile phone and performs data processing by running or executing the software program and/or the module stored in the memory 2220 and invoking data stored in the memory 2220. In an embodiment, the processor 2280 may include one or more processing units. In an embodiment, the processor 2280 may integrate an application processor and a modem processor. The application processor processes an operating system, a user interface, an application program, and the like. The modem processor processes wireless communication. The modem processor may not be integrated into the processor 2280.

The mobile phone further includes the power supply 2290 (such as a battery) for supplying power to the components. In an embodiment, the power supply may be logically connected to the processor 2280 through a power management system, and implement functions of charging, discharging, power consumption management, and the like through the power management system.

Although not shown in the figure, the mobile phone may further include a camera, a Bluetooth module, and the like. Details are not described herein again.

Operations performed by the terminal in the foregoing embodiments may be based on the structure of the terminal shown in FIG. 22.

The embodiments of this application further provide a computer device, including a memory and a processor. The memory has a computer program stored therein, and the processor, when executing the computer program, implements the operations of the method described in the foregoing embodiments.

The embodiments of this application further provide a computer-readable storage medium, having a computer program stored therein. The computer program, when executed by a processor, implements the operations of the method described in the foregoing embodiments.

The embodiments of this application further provide a computer program product, including a computer program. The computer program, when executed by a processor, implements the operations of the method described in the foregoing embodiments.

A person skilled in the art may clearly understand that, for convenience and conciseness of description, for specific operation processes of the foregoing system, apparatus, and unit, refer to the corresponding processes in the foregoing method embodiments. Details are not described herein again.

In the embodiments of this application, the term “module” or “unit” refers to a computer program or a part of a computer program with a predetermined function, which operates together with another related part to achieve a predetermined objective, and may be fully or partially implemented using software, hardware (such as a processing circuit or a memory), or a combination thereof. Similarly, one processor (or a plurality of processor or a plurality of memories) may be configured to implement one or more modules or units. In addition, each module or unit may be a part of an integrated module or unit that includes the functionality of the module or unit.

In several embodiments provided in this application, the disclosed system, apparatus, and method may be implemented in another manner. For example, the foregoing apparatus embodiments are merely exemplary. For example, the unit division is a merely logical function division and may be another division during practical implementation. For example, a plurality of units or components may be combined or integrated into another system, or some features may be ignored or not performed. In addition, the mutual couplings, direct couplings, or communication connections that are displayed or discussed may be indirect couplings or communication connections through some interfaces, apparatuses, or units, or may be implemented in electronic, mechanical, or another form.

The units described as separate parts may or may not be physically separate, and components displayed as units may or may not be physical units, that is, may be located in a same position, or may be distributed on a plurality of network units. Part or all of the units may be selected according to actual requirements to achieve the objectives of the solutions of the embodiments.

In addition, the function units in the embodiments of this application may be integrated into one processing unit, or the unit may exist physically as separate units, or two or more units are integrated into one unit. The foregoing integrated unit may be implemented in the form of hardware, or may be implemented in the form of a software function unit.

If the integrated unit is implemented in the form of the software functional unit and is sold or used as an independent product, the integrated unit may be stored in a computer-readable storage medium. Based on such an understanding, the technical solutions of this application, or the part contributing to the related art, or all or some of the technical solutions may be implemented in the form of a software product. The computer software product is stored in a storage medium and includes several instructions for causing a computer device (which may be a server, a terminal device, or the like) to perform all or some of the operations of the method described in the embodiments of this application. The storage medium includes any medium capable of storing a computer program, such as a Universal Serial Bus (USB) flash drive, a removable hard disk, a read-only memory (ROM), and a random-access memory (RAM), a magnetic disk, or an optical disc.

Based on the foregoing description, the foregoing embodiments are merely intended to describe the technical solutions of this application, and are not intended to limit this application. A person of ordinary skill in the art may understand that although this application has been described in detail with reference to the foregoing embodiments, modifications may be made to the technical solutions described in the foregoing embodiments, or equivalent replacements may be made to some technical features in the technical solutions. Such modifications or replacements do not cause the essence of the corresponding technical solutions to depart from the spirit and scope of the technical solutions in the embodiments of this application.

What is claimed is:

1. A method for concealing a first virtual character in a target virtual environment performed by a computer device, the method comprising:
after the first virtual character enters the target virtual environment, determining at least one type of environment material in a surrounding environment;
displaying an animation of adding a target camouflage pattern to the first virtual character within first time duration, and the target camouflage pattern being derived from the at least one type of environment material; and
switching the first virtual character from an exposed display state to a concealed display state when the first time duration ends, the first virtual character in the concealed display state being less visible in the target virtual environment.

2. The method according to claim 1, wherein the determining at least one type of environment material in the surrounding environment comprises:
displaying a concealment control after the first virtual character enters the target virtual environment; and
in response to an interaction operation on the concealment control, determining the at least one type of environment material in the surrounding environment in which the first virtual character is located; and
disabling display of the concealment control after the first virtual character leaves the target virtual environment.

3. The method according to claim 1, wherein the determining at least one type of environment material in the surrounding environment comprises:
displaying a first virtual prop on a virtual backpack interface after the first virtual character enters the target virtual environment; and
in response to a use operation for the first virtual prop, determining the at least one type of environment material in the surrounding environment in which the first virtual character is located.

4. The method according to claim 1, wherein the determining at least one type of environment material in the surrounding environment comprises:
obtaining preset mode information after the first virtual character enters the target virtual environment;
displaying a concealment control when the preset mode information indicates that an automatic concealment mode has been disabled; and
in response to an interaction operation for the concealment control, determining the at least one type of environment material in the surrounding environment in which the first virtual character is located.

5. The method according to claim 1, further comprising:
performing, within the first time duration, a countdown display of remaining duration of switching the first virtual character from the exposed display state to the concealed display state.

6. The method according to claim 1, further comprising:
in response to a concealment interruption operation for the first virtual character, stopping display of the animation of adding the target camouflage pattern to the first virtual character and starting display of an animation of removing the target camouflage pattern from the first virtual character.

7. The method according to claim 1, wherein the adding the target camouflage pattern to the first virtual character comprises:
obtaining a coating interface graphic based on the target camouflage pattern; and
performing transparency reduction and range expansion on the coating interface graphic within a preset field of view.

8. The method according to claim 1, after the switching the first virtual character from the exposed display state to the concealed display state, further comprising:
in response to a first action operation for the first virtual character, removing the target camouflage pattern from the first virtual character moment within second time duration; and
switching the first virtual character from the concealed display state to the exposed display state when the second time duration ends.

9. The method according to claim 1, further comprising:
displaying an assist concealment control when a second virtual character exists within a target range of the first virtual character, the second virtual character and the first virtual character belonging to a same game camp;
displaying an animation of adding the target camouflage pattern to the second virtual character in response to an interaction operation for the assist concealment control; and
switching the second virtual character from the exposed display state to the concealed display state.

10. The method according to claim 1, before the switching the first virtual character from the exposed display state to the concealed display state, further comprising:
obtaining a preset pixel corresponding to each type of environment material of the at least one type of environment material;
separately obtaining, based on N pixels comprised in the character material of the first virtual character, a to-be-blended environment material corresponding to each pixel, the to-be-blended environment material being an environment material closest to the pixel, and N being an integer greater than 1;
determining a preset pixel corresponding to each pixel based on the to-be-blended environment material corresponding to each pixel; and
performing material blending on each pixel and the corresponding preset pixel.

11. A computer device, comprising a memory and a processor, the memory having a computer program stored therein, and the computer program, when executed by the processor, causing the computer device to implement a method for concealing a first virtual character in a target virtual environment including:
after the first virtual character enters the target virtual environment, determining at least one type of environment material in a surrounding environment;
displaying an animation of adding a target camouflage pattern to the first virtual character within first time duration, and the target camouflage pattern being derived from the at least one type of environment material; and
switching the first virtual character from an exposed display state to a concealed display state when the first time duration ends, the first virtual character in the concealed display state being less visible in the target virtual environment.

12. The computer device according to claim 11, wherein the determining at least one type of environment material in the surrounding environment comprises:
displaying a concealment control after the first virtual character enters the target virtual environment; and
in response to an interaction operation on the concealment control, determining the at least one type of environment material in the surrounding environment in which the first virtual character is located; and
disabling display of the concealment control after the first virtual character leaves the target virtual environment.

13. The computer device according to claim 11, wherein the determining at least one type of environment material in the surrounding environment comprises:
displaying a first virtual prop on a virtual backpack interface after the first virtual character enters the target virtual environment; and
in response to a use operation for the first virtual prop, determining the at least one type of environment material in the surrounding environment in which the first virtual character is located.

14. The computer device according to claim 11, wherein the determining at least one type of environment material in the surrounding environment comprises:
obtaining preset mode information after the first virtual character enters the target virtual environment;
displaying a concealment control when the preset mode information indicates that an automatic concealment mode has been disabled; and
in response to an interaction operation for the concealment control, determining the at least one type of environment material in the surrounding environment in which the first virtual character is located.

15. The computer device according to claim 11, wherein the method further comprises:
performing, within the first time duration, a countdown display of remaining duration of switching the first virtual character from the exposed display state to the concealed display state.

16. The computer device according to claim 11, wherein the method further comprises:
in response to a concealment interruption operation for the first virtual character, stopping display of the animation of adding the target camouflage pattern to the first virtual character and starting display of an animation of removing the target camouflage pattern from the first virtual character.

17. The computer device according to claim 11, wherein the adding the target camouflage pattern to the first virtual character comprises:
obtaining a coating interface graphic based on the target camouflage pattern; and
performing transparency reduction and range expansion on the coating interface graphic within a preset field of view.

18. The computer device according to claim 11, wherein, after the switching the first virtual character from the exposed display state to the concealed display state, the method further comprises:
in response to a first action operation for the first virtual character, removing the target camouflage pattern from the first virtual character moment within second time duration; and
switching the first virtual character from the concealed display state to the exposed display state when the second time duration ends.

19. The computer device according to claim 11, wherein the method further comprises:
displaying an assist concealment control when a second virtual character exists within a target range of the first virtual character, the second virtual character and the first virtual character belonging to a same game camp;
displaying an animation of adding the target camouflage pattern to the second virtual character in response to an interaction operation for the assist concealment control; and
switching the second virtual character from the exposed display state to the concealed display state.

20. A non-transitory computer-readable storage medium, having a computer program stored therein, the computer program, when executed by a processor of a computer device, causing the computer device to implement a method for concealing a first virtual character in a target virtual environment including:
after the first virtual character enters the target virtual environment, determining at least one type of environment material in a surrounding environment;
displaying an animation of adding a target camouflage pattern to the first virtual character within first time duration, and the target camouflage pattern being derived from the at least one type of environment material; and
switching the first virtual character from an exposed display state to a concealed display state when the first time duration ends, the first virtual character in the concealed display state being less visible in the target virtual environment.
